(19) United States
(12) Patent Application Publication
(10) Pub. No.: US 2026/0031011 A1
(43) Pub. Date: Jan. 29, 2026

(54) DISPLAY APPARATUS, METHOD OF DRIVING THE SAME AND ELECTRONIC APPARATUS INCLUDING THE SAME

(71) Applicant: Samsung Display Co., LTD., Yongin-si (KR)

(72) Inventors: SEUNGJAE LEE, Yongin-si (KR); DAE-GWANG JANG, Yongin-si (KR)

(21) Appl. No.: 19/225,259

(22) Filed: Jun. 2, 2025

(30) Foreign Application Priority Data
Jul. 23, 2024 (KR) 10-2024-0097521

(51) Int. Cl. G09G 3/20

(52) U.S. Cl. CPC G09G 3/20; G09G 2310/0275; G09G 2310/0291; G09G 2310/0297; G09G 2320/0233

(57) ABSTRACT

A display apparatus includes a display panel, a data driver, a demux circuit and a driving controller. The data driver outputs a data voltage to the display panel. The demux circuit alternately outputs the data voltage to adjacent data lines of the display panel. The driving controller compensates a difference of kickback of input data which is generated due to a demux switching of the demux circuit.

This application claims priority to Korean Patent Application No. 10-2024-0097521, filed on Jul. 23, 2024, and all the benefits accruing therefrom under 35 U.S.C. § 119, the content of which in its entirety is herein incorporated by reference.

### BACKGROUND

### 1. Field

Embodiments of the invention relate to a display apparatus, a method of driving the display apparatus and an electronic apparatus including the display apparatus. More particularly, embodiments of the invention relate to a display apparatus with enhanced display quality, a method of driving the display apparatus and an electronic apparatus including the display apparatus.

### 2. Description of the Related Art

Generally, a display apparatus includes a display panel and a display panel driver. The display panel displays an image based on input image data. The display panel includes a plurality of gate lines, a plurality of data lines and a plurality of pixels. The display panel driver includes a gate driver, a data driver and a driving controller. The gate driver outputs gate signals to the gate lines. The data driver outputs data voltages to the data lines. The driving controller controls an operation of the gate driver and an operation of the data driver.

### SUMMARY

A display apparatus may include a demux structure for alternately applying the data voltages to the adjacent data lines to reduce a number of output amplifiers of the data driver. When the display apparatus includes the demux structure, a difference of degrees of kickback may be generated according to positions of the pixels such that a display quality of the display panel may be deteriorated.

Embodiments of the invention provide a display apparatus in which degrees of kickback of input data generated due to a demux switching of a demux circuit is compensated, thereby enhancing a display quality of a display panel.

Embodiments of the invention also provide a method of driving the display apparatus.

Embodiments of the invention also provide an electronic apparatus including the display apparatus.

In an embodiment of a display apparatus according to the invention, the display apparatus includes a display panel, a data driver, a demux circuit and a driving controller. In such an embodiment, the data driver outputs a data voltage to the display panel. In such an embodiment, the demux circuit alternately outputs the data voltage to adjacent data lines of the display panel. In such an embodiment, the driving controller compensates a difference of kickback of input data which is generated due to a demux switching of the demux circuit.

In an embodiment, the driving controller may determine a position corresponding to the input data in the display panel. In such an embodiment, the driving controller may compensate for the input data of the pixel having a relatively high degree of the kickback based on the position. In such an embodiment, the driving controller may not compensate for the input data of the pixel having a relatively low degree of the kickback based on the position.

In an embodiment, the driving controller may include a position determiner which receives first input data and second input data and determines a first position corresponding to the first input data in the display panel and a second position corresponding to the second input data in the display panel, a kickback compensation lookup table which receives the first input data and outputs an offset value corresponding to the first input data when a degree of kickback of a pixel in the first position is relatively high and an adder which adds the first input data and the offset value to generate first output data when the degree of kickback of the pixel in the first position is relatively high. In such an embodiment, the driving controller may output the second input data as second output data when the degree of kickback of a pixel in the second position is relatively low.

In an embodiment, the data driver may include an output amplifier which outputs the data voltage. In such an embodiment, the demux circuit may include a first switch connected to the output amplifier and activated in response to a first switching signal and a second switch connected to the output amplifier and activated in response to a second switching signal. In such an embodiment, the display panel may include a first gate lines which applies a first gate signal, a second gate line which applies a second gate signal, a third gate line which applies a third gate signal, a first data line connected to the first switch, a second data line connected to the second switch, an 1A pixel connected to the first gate line and the first data line, an 1B pixel connected to the first gate line and the second data line, a 2A pixel connected to the second gate line and the first data line, a 2B pixel connected to the second gate line and the second data line, a 3A pixel connected to the third gate line and the first data line and a 3B pixel connected to the third gate line and the second data line.

In an embodiment, the first switching signal may have an active level in a first period, the second switching signal may have an inactive level in the first period, the first gate signal may have an inactive level in the first period, the second gate signal may have an inactive level in the first period, the third gate signal may have an inactive level in the first period and the data voltage in the first period may be an 1A data voltage corresponding to the 1A pixel. In such an embodiment, the first switching signal may have an inactive level in a second period subsequent to the first period, the second switching signal may have an active level in the second period, the first gate signal may sequentially have the inactive level and an active level in the second period, the second gate signal may have the inactive level in the second period, the third gate signal may have the inactive level in the second period and the data voltage in the second period may be an 1B data voltage corresponding to the 1B pixel. In such an embodiment, the first switching signal may have the inactive level in a third period subsequent to the second period, the second switching signal may have the inactive level in the third period, the first gate signal may maintain the active level in the third period, the second gate signal may have the inactive level in the third period and the third gate signal may have the inactive level in the third period. In such an embodiment, the first switching signal may have the active level in a fourth period subsequent to the third period, the second switching signal may have the inactive level in the fourth period, the first gate signal may have the inactive level in the fourth period, the second gate signal may have the inactive level in the fourth period, the third gate signal may have the inactive level in the fourth period and the data voltage in the fourth period may be a 2A data voltage corresponding to the 2A pixel. In such an embodiment, the first switching signal may have the inactive level in a fifth period subsequent to the fourth period, the second switching signal may have the active level in the fifth period, the first gate signal may have the inactive level in the fifth period, the second gate signal may sequentially have the inactive level and an active level in the fifth period, the third gate signal may have the inactive level in the fifth period and the data voltage in the fifth period may be a 2B data voltage corresponding to the 2B pixel. In such an embodiment, the first switching signal may have the inactive level in a sixth period subsequent to the fifth period, the second switching signal may have the inactive level in the sixth period, the first gate signal may have the inactive level in the sixth period, the second gate signal may maintain the active level in the sixth period and the third gate signal may have the inactive level in the sixth period. In such an embodiment, the first switching signal may have the active level in a seventh period subsequent to the sixth period, the second switching signal may have the inactive level in the seventh period, the first gate signal may have the inactive level in the seventh period, the second gate signal may have the inactive level in the seventh period, the third gate signal may have the inactive level in the seventh period and the data voltage in the seventh period may be a 3A data voltage corresponding to the 3A pixel. In such an embodiment, the first switching signal may have the inactive level in an eighth period subsequent to the seventh period, the second switching signal may have the active level in the eighth period, the first gate signal may have the inactive level in the eighth period, the second gate signal may have the inactive level in the eighth period, the third gate signal may sequentially have the inactive level and an active level in the eighth period and the data voltage in the eighth period may be a 3B data voltage corresponding to the 3B pixel. In such an embodiment, the first switching signal may have the inactive level in a ninth period subsequent to the eighth period, the second switching signal may have the inactive level in the ninth period, the first gate signal may have the inactive level in the ninth period, the second gate signal may have the inactive level in the ninth period and the third gate signal may maintain the active level in the ninth period.

In an embodiment, a degree of kickback of the 1A pixel may be greater than a degree of kickback of the 1B pixel. In such an embodiment, a degree of kickback of the 2A pixel may be greater than a degree of kickback of the 2B pixel. In such an embodiment, a degree of kickback of the 3A pixel may be greater than a degree of kickback of the 3B pixel.

In an embodiment, the first switching signal may have an active level in a first period, the second switching signal may have an inactive level in the first period, the first gate signal may have an inactive level in the first period, the second gate signal may have an inactive level in the first period, the third gate signal may have an inactive level in the first period and the data voltage in the first period may be an 1A data voltage corresponding to the 1A pixel. In such an embodiment, the first switching signal may have an inactive level in a second period subsequent to the first period, the second switching signal may have an active level in the second period, the first gate signal may sequentially have the inactive level and an active level in the second period, the second gate signal may have the inactive level in the second period, the third gate signal may have the inactive level in the second period and the data voltage in the second period may be an 1B data voltage corresponding to the 1B pixel. In such an embodiment, the first switching signal may have the inactive level in a third period subsequent to the second period, the second switching signal may have the inactive level in the third period, the first gate signal may maintain the active level in the third period, the second gate signal may have the inactive level in the third period and the third gate signal may have the inactive level in the third period. In such an embodiment, the first switching signal may have the inactive level in a fourth period subsequent to the third period, the second switching signal may have the active level in the fourth period, the first gate signal may have the inactive level in the fourth period, the second gate signal may have the inactive level in the fourth period, the third gate signal may have the inactive level in the fourth period and the data voltage in the fourth period may be a 2B data voltage corresponding to the 2B pixel. In such an embodiment, the first switching signal may have the active level in a fifth period subsequent to the fourth period, the second switching signal may have the inactive level in the fifth period, the first gate signal may have the inactive level in the fifth period, the second gate signal may sequentially have the inactive level and an active level in the fifth period, the third gate signal may have the inactive level in the fifth period and the data voltage in the fifth period may be a 2A data voltage corresponding to the 2A pixel. In such an embodiment, the first switching signal may have the inactive level in a sixth period subsequent to the fifth period, the second switching signal may have the inactive level in the sixth period, the first gate signal may have the inactive level in the sixth period, the second gate signal may maintain the active level in the sixth period and the third gate signal may have the inactive level in the sixth period. In such an embodiment, the first switching signal may have the active level in a seventh period subsequent to the sixth period, the second switching signal may have the inactive level in the seventh period, the first gate signal may have the inactive level in the seventh period, the second gate signal may have the inactive level in the seventh period, the third gate signal may have the inactive level in the seventh period and the data voltage in the seventh period may be a 3A data voltage corresponding to the 3A pixel. In such an embodiment, the first switching signal may have the inactive level in an eighth period subsequent to the seventh period, the second switching signal may have the active level in the eighth period, the first gate signal may have the inactive level in the eighth period, the second gate signal may have the inactive level in the eighth period, the third gate signal may sequentially have the inactive level and an active level in the eighth period and the data voltage in the eighth period may be a 3B data voltage corresponding to the 3B pixel. In such an embodiment, the first switching signal may have the inactive level in a ninth period subsequent to the eighth period, the second switching signal may have the inactive level in the ninth period, the first gate signal may have the inactive level in the ninth period, the second gate signal may have the inactive level in the ninth period and the third gate signal may maintain the active level in the ninth period.

In an embodiment, a degree of kickback of the 1A pixel may be greater than a degree of kickback of the 1B pixel. In such an embodiment, a degree of kickback of the 2B pixel may be greater than a degree of kickback of the 2A pixel. In such an embodiment, a degree of kickback of the 3A pixel may be greater than a degree of kickback of the 3B pixel.

In an embodiment, the first switching signal may have an active level in a first period, the second switching signal may have an inactive level in the first period, the first gate signal may have an inactive level in the first period, the second gate signal may have an inactive level in the first period, the third gate signal may have an inactive level in the first period and the data voltage in the first period may be an 1A data voltage corresponding to the 1A pixel. In such an embodiment, the first switching signal may have an inactive level in a second period subsequent to the first period, the second switching signal may have an active level in the second period, the first gate signal may sequentially have the inactive level and an active level in the second period, the second gate signal may have the inactive level in the second period, the third gate signal may have the inactive level in the second period and the data voltage in the second period may be an 1B data voltage corresponding to the 1B pixel. In such an embodiment, the first switching signal may have the inactive level in a third period subsequent to the second period, the second switching signal may have the active level in the third period, the first gate signal may maintain the active level in the third period, the second gate signal may have the inactive level in the third period and the third gate signal may have the inactive level in the third period. In such an embodiment, the first switching signal may have the inactive level in a fourth period subsequent to the third period, the second switching signal may have the active level in the fourth period, the first gate signal may have the inactive level in the fourth period, the second gate signal may have the inactive level in the fourth period, the third gate signal may have the inactive level in the fourth period and the data voltage in the fourth period may be a 2B data voltage corresponding to the 2B pixel. In such an embodiment, the first switching signal may have the active level in a fifth period subsequent to the fourth period, the second switching signal may have the inactive level in the fifth period, the first gate signal may have the inactive level in the fifth period, the second gate signal may sequentially have the inactive level and an active level in the fifth period, the third gate signal may have the inactive level in the fifth period and the data voltage in the fifth period may be a 2A data voltage corresponding to the 2A pixel. In such an embodiment, the first switching signal may have the active level in a sixth period subsequent to the fifth period, the second switching signal may have the inactive level in the sixth period, the first gate signal may have the inactive level in the sixth period, the second gate signal may maintain the active level in the sixth period and the third gate signal may have the inactive level in the sixth period. In such an embodiment, the first switching signal may have the active level in a seventh period subsequent to the sixth period, the second switching signal may have the inactive level in the seventh period, the first gate signal may have the inactive level in the seventh period, the second gate signal may have the inactive level in the seventh period, the third gate signal may have the inactive level in the seventh period and the data voltage in the seventh period may be a 3A data voltage corresponding to the 3A pixel. In such an embodiment, the first switching signal may have the inactive level in an eighth period subsequent to the seventh period, the second switching signal may have the active level in the eighth period, the first gate signal may have the inactive level in the eighth period, the second gate signal may have the inactive level in the eighth period, the third gate signal may sequentially have the inactive level and an active level in the eighth period and the data voltage in the eighth period may be a 3B data voltage corresponding to the 3B pixel. In such an embodiment, the first switching signal may have the inactive level in a ninth period subsequent to the eighth period, the second switching signal may have the inactive level in the ninth period, the first gate signal may have the inactive level in the ninth period, the second gate signal may have the inactive level in the ninth period and the third gate signal may maintain the active level in the ninth period.

In an embodiment, a degree of kickback of the 1A pixel may be greater than a degree of kickback of the 1B pixel. In such an embodiment, a degree of kickback of the 2B pixel may be greater than a degree of kickback of the 2A pixel. In such an embodiment, a degree of kickback of the 3A pixel may be greater than a degree of kickback of the 3B pixel.

In an embodiment, the data driver may include an output amplifier which outputs the data voltage. In such an embodiment, the demux circuit may include a first switch connected to the output amplifier and activated in response to a first switching signal, a second switch connected to the output amplifier and activated in response to a second switching signal and a third switch connected to the output amplifier and activated in response to a third switching signal. In such an embodiment, the display panel may include a first gate lines which applies a first gate signal, a second gate line which applies a second gate signal, a third gate line which applies a third gate signal, a first data line connected to the first switch, a second data line connected to the second switch, a third data line connected to the third switch, an 1A pixel connected to the first gate line and the first data line, an 1B pixel connected to the first gate line and the second data line, an 1C pixel connected to the first gate line and the third data line, a 2A pixel connected to the second gate line and the first data line, a 2B pixel connected to the second gate line and the second data line, a 2C pixel connected to the second gate line and the third data line, a 3A pixel connected to the third gate line and the first data line, a 3B pixel connected to the third gate line and the second data line and a 3C pixel connected to the third gate line and the third data line.

In an embodiment, the first switching signal may have an active level in a first period, the second switching signal may have an inactive level in the first period, the third switching signal may have an inactive level in the first period, the first gate signal may have an inactive level in the first period, the second gate signal may have an inactive level in the first period, the third gate signal may have an inactive level in the first period and the data voltage in the first period may be an 1A data voltage corresponding to the 1A pixel. In such an embodiment, the first switching signal may have an inactive level in a second period subsequent to the first period, the second switching signal may have an active level in the second period, the third switching signal may have the inactive level in the second period, the first gate signal may have the inactive level in the second period, the second gate signal may have the inactive level in the second period, the third gate signal may have the inactive level in the second period and the data voltage level in the second period may be an 1B data voltage corresponding to the 1B pixel. In such an embodiment, the first switching signal may have the inactive level in a third period subsequent to the second period, the second switching signal may have the inactive level in the third period, the third switching signal may have an active level in the third period, the first gate signal may sequentially have the inactive level and an active level in the third period, the second gate signal may have the inactive level in the third period, the third gate signal may have the inactive level in the third period and the data voltage in the third period may be an 1C data voltage corresponding to the 1C pixel. In such an embodiment, the first switching signal may have the inactive level in a fourth period subsequent to the third period, the second switching signal may have the inactive level in the fourth period, the third switching signal may have the inactive level in the fourth period, the first gate signal may maintain the active level in the fourth period, the second gate signal may have the inactive level in the fourth period and the third gate signal may have the inactive level in the fourth period. In such an embodiment, the first switching signal may have the active level in a fifth period subsequent to the fourth period, the second switching signal may have the inactive level in the fifth period, the third switching signal may have the inactive level in the fifth period, the first gate signal may have the inactive level in the fifth period, the second gate signal may have the inactive level in the fifth period, the third gate signal may have the inactive level in the fifth period and the data voltage in the fifth period may be a 2A data voltage corresponding to the 2A pixel. In such an embodiment, the first switching signal may have the inactive level in a sixth period subsequent to the fifth period, the second switching signal may have the active level in the sixth period, the third switching signal may have the inactive level in the sixth period, the first gate signal may have the inactive level in the sixth period, the second gate signal may have the inactive level in the sixth period, the third gate signal may have the inactive level in the sixth period and the data voltage in the sixth period may be a 2B data voltage corresponding to the 2B pixel. In such an embodiment, the first switching signal may have the inactive level in a seventh period subsequent to the sixth period, the second switching signal may have the inactive level in the seventh period, the third switching signal may have the active level in the seventh period, the first gate signal may have the inactive level in the seventh period, the second gate signal may sequentially have the inactive level and an active level in the seventh period, the third gate signal may have the inactive level in the seventh period and the data voltage in the seventh period may be a 2C data voltage corresponding to the 2C pixel. In such an embodiment, the first switching signal may have the inactive level in an eighth period subsequent to the seventh period, the second switching signal may have the inactive level in the eighth period, the third switching signal may have the inactive level in the eighth period, the first gate signal may have the inactive level in the eighth period, the second gate signal may maintain the active level in the eighth period and the third gate signal may have the inactive level in the eighth period. In such an embodiment, the first switching signal may have the active level in a ninth period subsequent to the eighth period, the second switching signal may have the inactive level in the ninth period, the third switching signal may have the inactive level in the ninth period, the first gate signal may have the inactive level in the ninth period, the second gate signal may have the inactive level in the ninth period, the third gate signal may have the inactive level in the ninth period and the data voltage in the ninth period may be a 3A data voltage corresponding to the 3A pixel. In such an embodiment, the first switching signal may have the inactive level in a tenth period subsequent to the ninth period, the second switching signal may have the active level in the tenth period, the third switching signal may have the inactive level in the tenth period, the first gate signal may have the inactive level in the tenth period, the second gate signal may have the inactive level in the tenth period, the third gate signal may have the inactive level in the tenth period and the data voltage in the tenth period may be a 3B data voltage corresponding to the 3B pixel. In such an embodiment, the first switching signal may have the inactive level in an eleventh period subsequent to the tenth period, the second switching signal may have the inactive level in the eleventh period, the third switching signal may have the active level in the eleventh period, the first gate signal may have the inactive level in the eleventh period, the second gate signal may have the inactive level in the eleventh period, the third gate signal may sequentially have the inactive level and an active level in the eleventh period and the data voltage level in the eleventh period may be a 3C data voltage corresponding to the 3C pixel. In such an embodiment, the first switching signal may have the inactive level in a twelfth period subsequent to the eleventh period, the second switching signal may have the inactive level in the twelfth period, the third switching signal may have the inactive level in the twelfth period, the first gate signal may have the inactive level in the twelfth period, the second gate signal may have the inactive level in the twelfth period and the third gate signal may maintain the active level in the twelfth period.

In an embodiment, a degree of kickback of the 1A pixel and a degree of kickback of the 1B pixel may be greater than a degree of kickback of the 1C pixel. In such an embodiment, a degree of kickback of the 2A pixel and a degree of kickback of the 2B pixel may be greater than a degree of kickback of the 2C pixel. In such an embodiment, a degree of kickback of the 3A pixel and a degree of kickback of the 3B pixel may be greater than a degree of kickback of the 3C pixel.

In an embodiment of a method of driving a display apparatus according to the invention, the method includes compensating a difference of kickback of input data generated due to a demux switching of a demux circuit, generating a data voltage based on output data in which the difference of the kickback is compensated and outputting the data voltage to adjacent data lines of a display panel using the demux circuit.

In an embodiment, the compensating the difference of the kickback of the input data may include determining a position corresponding to the input data in the display panel. In such an embodiment, input data of a pixel having a relatively high degree of kickback may be compensated based on the position. In such an embodiment, input data of a pixel having a relatively low degree of kickback may not be compensated based on the position.

In an embodiment, the compensating the difference of the kickback of the input data may further include determining an offset value corresponding to the input data when it is determined that a compensation of the input data is to be performed and adding the input data and the offset value when it is determined that the compensation of the input data is to be performed.

In an embodiment, a data driver may include an output amplifier which outputs the data voltage. In such an embodiment, the demux circuit may include a first switch connected to the output amplifier and activated in response to a first switching signal and a second switch connected to the output amplifier and activated in response to a second switching signal. In such an embodiment, the display panel may include a first gate lines which applies a first gate signal, a second gate line which applies a second gate signal, a third gate line which applies a third gate signal, a first data line connected to the first switch, a second data line connected to the second switch, an 1A pixel connected to the first gate line and the first data line, an 1B pixel connected to the first gate line and the second data line, a 2A pixel connected to the second gate line and the first data line, a 2B pixel connected to the second gate line and the second data line, a 3A pixel connected to the third gate line and the first data line and a 3B pixel connected to the third gate line and the second data line.

In an embodiment, a data driver may include an output amplifier which outputs the data voltage. In such an embodiment, the demux circuit may include a first switch connected to the output amplifier and activated in response to a first switching signal, a second switch connected to the output amplifier and activated in response to a second switching signal and a third switch connected to the output amplifier and activated in response to a third switching signal. In such an embodiment, the display panel may include a first gate lines which applies a first gate signal, a second gate line which applies a second gate signal, a third gate line which applies a third gate signal, a first data line connected to the first switch, a second data line connected to the second switch, a third data line connected to the third switch, an 1A pixel connected to the first gate line and the first data line, an 1B pixel connected to the first gate line and the second data line, an 1C pixel connected to the first gate line and the third data line, a 2A pixel connected to the second gate line and the first data line, a 2B pixel connected to the second gate line and the second data line, a 2C pixel connected to the second gate line and the third data line, a 3A pixel connected to the third gate line and the first data line, a 3B pixel connected to the third gate line and the second data line and a 3C pixel connected to the third gate line and the third data line.

In an embodiment of an electronic apparatus according to the invention, the electronic apparatus includes a display panel, a data driver, a demux circuit, a driving controller and a processor. In such an embodiment, the data driver outputs a data voltage to the display panel. In such an embodiment, the demux circuit alternately outputs the data voltage to adjacent data lines of the display panel. In such an embodiment, the driving controller compensates a difference of kickback of input data which is generated due to a demux switching of the demux circuit. The processor outputs input image data and an input control signal to the driving controller.

According to embodiments of the display apparatus, the method of driving the display apparatus and the electronic apparatus including the display apparatus, the display apparatus may include the demux circuit that alternately outputs the data voltages to the adjacent data lines such that a number of the output amplifiers of the data driver may be reduced. Thus, a manufacturing cost of the display apparatus may be reduced.

In such embodiments, a difference of degrees of kickback of the input data generated due to the demux switching of the demux circuit may be compensated such that a display quality of the display panel may be enhanced.

### BRIEF DESCRIPTION OF THE DRAWINGS

The above and other features of embodiments of the invention will become more apparent by describing in detailed embodiments thereof with reference to the accompanying drawings, in which:

FIG. 1 is a block diagram illustrating a display apparatus according to an embodiment of the invention;

FIG. 2 is a circuit diagram illustrating a data driver of FIG. 1, a display panel of FIG. 1 and a demux circuit;

FIG. 3 is a signal timing diagram illustrating a switching signal applied to the demux circuit of FIG. 2, a gate signal and a data voltage which are applied to the display panel of FIG. 1;

FIG. 4 is a block diagram illustrating a driving controller of FIG. 1;

FIG. 5A is a graph illustrating first output data of FIG. 4 for first input data of FIG. 4 for which a kickback compensation is desired;

FIG. 5B is a graph illustrating second output data of FIG. 4 for second input data of FIG. 4 for which the kickback compensation is not desired;

FIG. 6A is a circuit diagram illustrating the data driver of FIG. 1, the display panel of FIG. 1 and the demux circuit of FIG. 2 before the kickback compensation;

FIG. 6B is a circuit diagram illustrating the data driver of FIG. 1, the display panel of FIG. 1 and the demux circuit of FIG. 2 after the kickback compensation;

FIG. 7A is a graph illustrating a luminance of the display panel of FIG. 1 according to grayscale values before the kickback compensation;

FIG. 7B is a graph illustrating a luminance of the display panel of FIG. 1 according to the grayscale values after the kickback compensation;

FIG. 8 is a flowchart illustrating an embodiment of a method of driving the display apparatus of FIG. 1;

FIG. 9 is a signal timing diagram illustrating a switching signal applied to a demux circuit of a display apparatus according to an embodiment of the invention, a gate signal and a data voltage which are applied to a display panel;

FIG. 10A is a circuit diagram illustrating a data driver, the display panel and the demux circuit of the display apparatus of FIG. 9 before a kickback compensation;

FIG. 10B is a circuit diagram illustrating the data driver, the display panel and the demux circuit of the display apparatus of FIG. 9 after the kickback compensation;

FIG. 11 is a signal timing diagram illustrating a switching signal applied to a demux circuit of a display apparatus according to an embodiment of the invention, a gate signal and a data voltage which are applied to a display panel;

FIG. 12 is a circuit diagram illustrating a data driver, a display panel and a demux circuit of a display apparatus according to an embodiment of the invention;

FIG. 13 is a signal timing diagram illustrating a switching signal applied to the demux circuit of the display apparatus of FIG. 12, a gate signal and a data voltage which are applied to a display panel of the display apparatus of FIG. 12;

FIG. 14A is a circuit diagram illustrating the data driver, the display panel and the demux circuit of the display apparatus of FIG. 12 before a kickback compensation;

FIG. 14B is a circuit diagram illustrating the data driver, the display panel and the demux circuit of the display apparatus of FIG. 12 after the kickback compensation;

FIG. 15 is a block diagram illustrating an electronic apparatus according to an embodiment of the invention;

FIG. 16 is a diagram illustrating an embodiment in which the electronic apparatus of FIG. 15 is implemented as a smartphone;

FIG. 17 is a diagram illustrating an embodiment in which the electronic apparatus of

FIG. 15 is implemented as a monitor; and

FIG. 18 is a block diagram illustrating an electronic apparatus according to an embodiment of the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

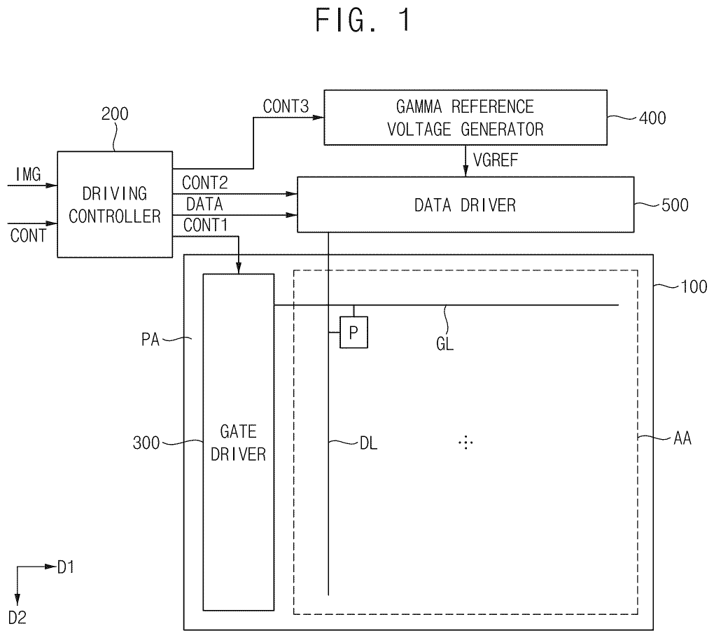

FIG. 1 is a block diagram illustrating a display apparatus according to an embodiment of the invention.

Referring to FIG. 1, an embodiment of the display apparatus includes a display panel 100 and a display panel driver. The display panel driver drives the display panel 100. The display panel driver includes a driving controller 200, a gate driver 300, a gamma reference voltage generator 400 and a data driver 500.

In an embodiment, for example, the driving controller 200 and the data driver 500 may be integrally formed as a single driver or chip. In an embodiment, for example, the driving controller 200, the gamma reference voltage generator 400 and the data driver 500 may be integrally formed as a single driver or chip. A driving module including at least the driving controller 200 and the data driver 500 which are integrally formed may be called to a timing controller embedded data driver (TED).

The display panel 100 has a display region AA on which an image is displayed and a peripheral region PA adjacent to the display region AA.

The display panel 100 includes a plurality of gate lines GL, a plurality of data lines DL and a plurality of pixels P connected to the gate lines GL and the data lines DL. The gate lines GL may extend in a first direction D1 and the data lines DL may extend in a second direction D2 crossing the first direction D1.

The driving controller 200 may receive input image data IMG and an input control signal CONT from an external apparatus (e.g., an application processor). In an embodiment, for example, the input image data IMG may include red image data, green image data and blue image data. In an embodiment, for example, the input image data IMG may include white image data. For example, the input image data IMG may include magenta image data, yellow image data and cyan image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The gate driver 300 may generate gate signals driving the gate lines GL in response to the first control signal CONT1 received from the driving controller 200. The gate driver 300 may output the gate signals to the gate lines GL. In an embodiment, for example, the gate driver 300 may sequentially output the gate signals to the gate lines GL. In an embodiment, for example, the gate driver 300 may be mounted on the peripheral region PA of the display panel 100. In an embodiment, for example, the gate driver 300 may be integrated on the peripheral region PA of the display panel 100.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500.

In an embodiment, the gamma reference voltage generator 400 may be disposed in the driving controller 200, or in the data driver 500.

The data driver 500 may receive the second control signal CONT2 and the data signal DATA from the driving controller 200, and receives the gamma reference voltages VGREF from the gamma reference voltage generator 400. The data driver 500 may convert the data signal DATA into data voltages having an analog type using the gamma reference voltages VGREF. The data driver 500 may output the data voltages to the data lines DL.

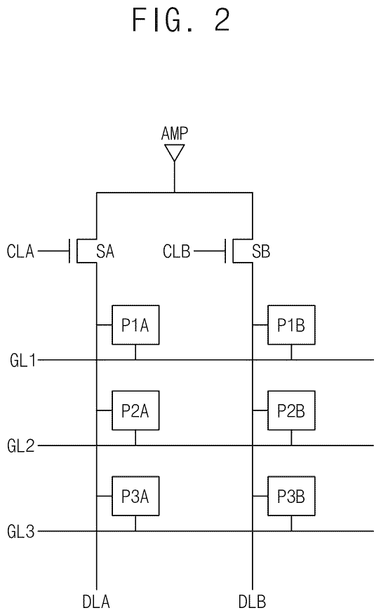

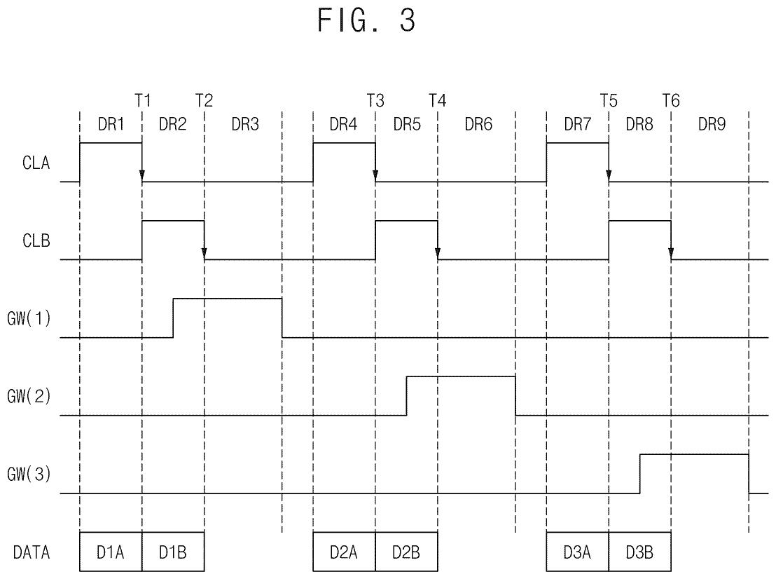

FIG. 2 is a circuit diagram illustrating the data driver 500 of FIG. 1, the display panel 100 of FIG. 1 and a demux circuit. FIG. 3 is a signal timing diagram illustrating a switching signal CLA and CLB applied to the demux circuit of FIG. 2, the gate signal GW(1), GW(2) and GW(3) and the data voltage D1A, D1B, D2A, D2B, D3A and D3B which are applied to the display panel 100 of FIG. 1.

Referring to FIGS. 1 to 3, in an embodiment, the demux circuit may alternately output the data voltages to the adjacent data lines of the display panel 100.

The data driver 500 may include an output amplifier AMP that outputs the data voltage.

The demux circuit may include a first switch SA connected to the output amplifier AMP and activated in response to a first switching signal CLA and a second switch SB connected to the output amplifier AMP and activated in response to a second switching signal CLB.

The display panel 100 may include a first gate line GL1 that apples a first gate signal GW1, a second gate line GL2 that apples a second gate signal GW2, a third gate lines GL3 that apples a third gate signal GW3, a first data line DLA connected to the first switch SA, a second data line DLB connected to the second switch SB, an 1A pixel (i.e., a first pixel in a first column) PIA connected to the first gate line GL1 and the first data line DLA, an 1B pixel (i.e., a first pixel in a second column) PIB connected to the first gate line GL1 and the second data line DLB, a 2A pixel (i.e., a second pixel in the first column) P2A connected to the second gate line GL2 and the first data line DLA, a 2B pixel (i.e., a second pixel in the second column) P2B connected to the second gate line GL2 and the second data line DLB, a 3A pixel (i.e., a third pixel in the first column) P3A connected to the third gate line GL3 and the first data line DLA and a 3B pixel (i.e., a third pixel in the second column) P3B connected to the third gate line GL3 and the second data line DLB.

In an embodiment, as shown in FIG. 3, the first switching signal CLA may have an active level in a first period DR1, the second switching signal CLB may have an inactive level in the first period DR1, the first gate signal GW(1) may have an inactive level in the first period DR1, the second gate signal GW(2) may have an inactive level in the first period DR1, the third gate signal GW(3) may have an inactive level in the first period DR1 and the data voltage may be an 1A data voltage D1A corresponding to the 1A pixel PIA. The first switching signal CLA may have an inactive level in a second period DR2 subsequent to the first period DR1, the second switching signal CLB may have an active level in the second period DR2, the first gate signal GW(1) may sequentially have the inactive level and an active level in the second period DR2, the second gate signal GW(2) may have the inactive level in the second period DR2, the third gate signal GW(3) may have the inactive level in the second period DR2 and the data voltage may be an 1B data voltage D1B corresponding to the 1B pixel PIB. The first switching signal CLA may have the inactive level in a third period DR3 subsequent to the second period DR2, the second switching signal CLB may have the inactive level in the third period DR3, the first gate signal GW(1) may maintain the active level in the third period DR3, the second gate signal GW(2) may have the inactive level in the third period DR3 and the third gate signal GW(3) may have the inactive level in the third period DR3. The first switching signal CLA may have the active level in a fourth period DR4 subsequent to the third period DR3, the second switching signal CLB may have the inactive level in the fourth period DR4, the first gate signal GW(1) may have the inactive level in the fourth period DR4, the second gate signal GW(2) may have the inactive level in the fourth period DR4, the third gate signal GW(3) may have the inactive level in the fourth period DR4 and the data voltage may be a 2A data voltage D2A corresponding to the 2A pixel P2A. The first switching signal CLA may have the inactive level in a fifth period DR5 subsequent to the fourth period DR4, the second switching signal CLB may have the active level in the fifth period DR5, the first gate signal GW(1) may have the inactive level in the fifth period DR5, the second gate signal GW(2) may sequentially have the inactive level and an active level in the fifth period DR5, the third gate signal GW(3) may have the inactive level in the fifth period DR5 and the data voltage may be a 2B data voltage D2B corresponding to the 2B pixel P2B. The first switching signal CLA may have the inactive level in a sixth period DR6 subsequent to the fifth period DR5, the second switching signal CLB may have the inactive level in the sixth period DR6, the first gate signal GW(1) may have the inactive level in the sixth period DR6, the second gate signal GW(2) may maintain the active level in the sixth period DR6 and the third gate signal GW(3) may have the inactive level in the sixth period DR6. The first switching signal CLA may have the active level in a seventh period DR7 subsequent to the sixth period DR6, the second switching signal CLB may have the inactive level in the seventh period DR7, the first gate signal GW(1) may have the inactive level in the seventh period DR7, the second gate signal GW(2) may have the inactive level in the seventh period DR7, the third gate signal GW(3) may have the inactive level in the seventh period DR7 and the data voltage may be a 3A data voltage D3A corresponding to the 3A pixel P3A. The first switching signal CLA may have the inactive level in an eighth period DR8 subsequent to the seventh period DR7, the second switching signal CLB may have the active level in the eighth period DR8, the first gate signal GW(1) may have the inactive level in the eighth period DR8, the second gate signal GW(2) may have the inactive level in the eighth period DR8, the third gate signal GW(3) may sequentially have the inactive level and an active level in the eighth period DR8 and the data voltage may be a 3B data voltage D3B corresponding to the 3B pixel P3B. The first switching signal CLA may have the inactive level in a ninth period DR9 subsequent to the eighth period DR8, the second switching signal CLB may have the inactive level in the ninth period DR9, the first gate signal GW(1) may have the inactive level in the ninth period DR9, the second gate signal GW(2) may have the inactive level in the ninth period DR9 and the third gate signal GW(3) may maintain the active level in the ninth period DR9.

When the first switching signal CLA has the active level in the first period DR1, the first switch SA is turned on such that the 1A data voltage D1A may be charged at a capacitance of the first data line DLA.

When the second switching signal CLB has the active level in the second period DR2, the second switch SB is turned on such that the 1B data voltage D1B may be charged at a capacitance of the second data line DLB.

In such an embodiment, the first gate signal GW(1) has the inactive level at a first time point T1 which is a falling edge of the first switching signal CLA such that the first data line DLA may not be directly connected to the 1A pixel PIA but be in a floating state. Thus, the 1A data voltage D1A charged at the capacitance of the first data line DLA may be greatly affected by kickback at the first time point T1 which is the falling edge of the first switching signal CLA.

In such an embodiment, the first gate signal GW(1) has the active level at a second time point T2 which is a falling edge of the second switching signal CLB such that the second data line DLB may be directly connected to the 1B pixel PIB. Thus, the 1B data voltage D1B charged at the capacitance of the second data line DLB may be less affected by kickback at the second time point T2 which is the falling edge of the second switching signal CLB.

Due to the above described difference, a degree of kickback of the 1A pixel PIA may be greater than a degree of kickback of the 1B pixel PIB. When the kickback difference is not compensated, a luminance of the 1A pixel PIA may be less than a luminance of the 1B pixel PIB for a same grayscale value.

In such an embodiment, the second gate signal GW(2) has the inactive level at a third time point T3 which is a falling edge of the first switching signal CLA such that the first data line DLA may not be directly connected to the 2A pixel P2A but be in a floating state. Thus, the 2A data voltage D2A charged at the capacitance of the first data line DLA may be greatly affected by kickback at the third time point T3 which is the falling edge of the first switching signal CLA.

In such an embodiment, the second gate signal GW(2) has the active level at a fourth time point T4 which is a falling edge of the second switching signal CLB such that the second data line DLB may be directly connected to the 2B pixel P2B. Thus, the 2B data voltage D2B charged at the capacitance of the second data line DLB may be less affected by kickback at the fourth time point T4 which is the falling edge of the second switching signal CLB.

Due to the above described difference, a degree of kickback of the 2A pixel P2A may be greater than a degree of kickback of the 2B pixel P2B. When the kickback difference is not compensated, a luminance of the 2A pixel P2A may be less than a luminance of the 2B pixel P2B for the same grayscale value.

In such an embodiment, the third gate signal GW(3) has the inactive level at a fifth time point T5 which is a falling edge of the first switching signal CLA such that the first data line DLA may not be directly connected to the 3A pixel P3A but be in a floating state. Thus, the 3A data voltage D3A charged at the capacitance of the first data line DLA may be greatly affected by kickback at the fifth time point T5 which is the falling edge of the first switching signal CLA.

In such an embodiment, the third gate signal GW(3) has the active level at a sixth time point T6 which is a falling edge of the second switching signal CLB such that the second data line DLB may be directly connected to the 3B pixel P3B. Thus, the 3B data voltage D3B charged at the capacitance of the second data line DLB may be less affected by kickback at the sixth time point T6 which is the falling edge of the second switching signal CLB.

Due to the above described difference, a degree of kickback of the 3A pixel P3A may be greater than a degree of kickback of the 3B pixel P3B. When the kickback difference is not compensated, a luminance of the 3A pixel P3A may be less than a luminance of the 3B pixel P3B for the same grayscale value.

As shown in the second period DR2, an active period of the first gate signal GW(1) may not (temporally) overlap an active period of the first switching signal CLA but (temporally) overlap an active period of the second switching signal CLB. As shown in the fifth period DR5, an active period of the second gate signal GW(2) may not (temporally) overlap an active period of the first switching signal CLA but (temporally) overlap an active period of the second switching signal CLB. As shown in the eighth period DR8, an active period of the third gate signal GW(3) may not (temporally) overlap an active period of the first switching signal CLA but (temporally) overlap an active period of the second switching signal CLB. Accordingly, the kickback difference may be generated between the pixels.

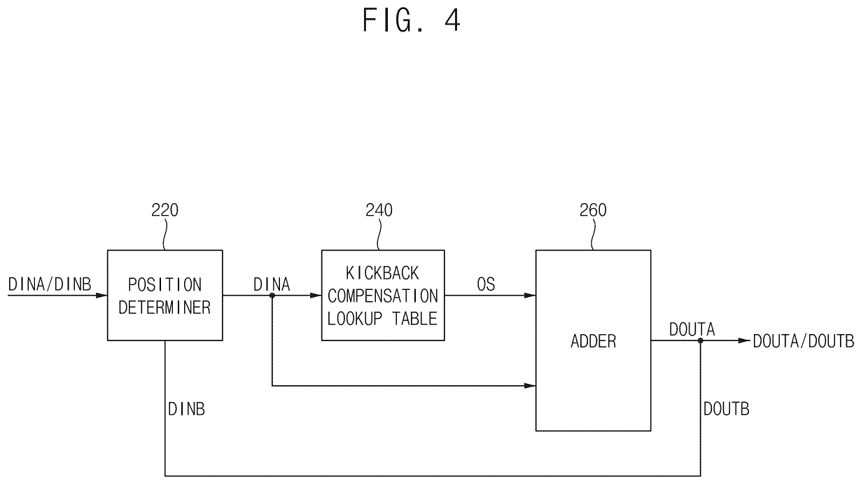

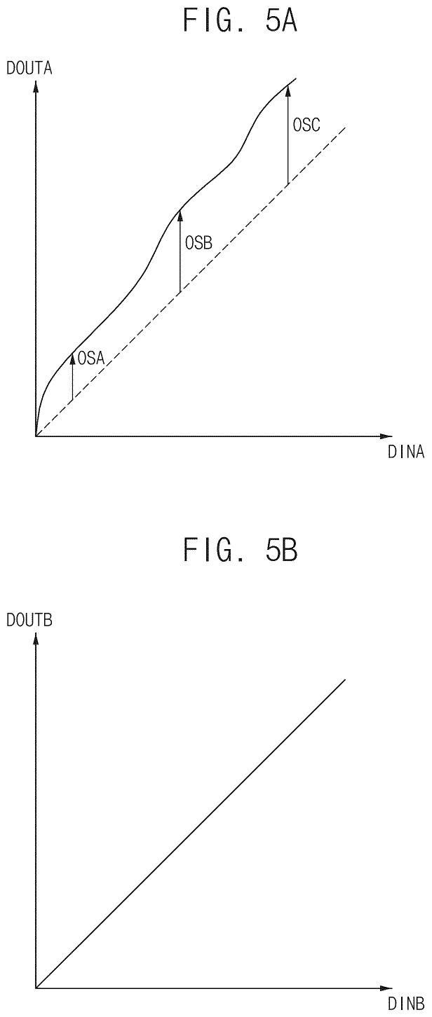

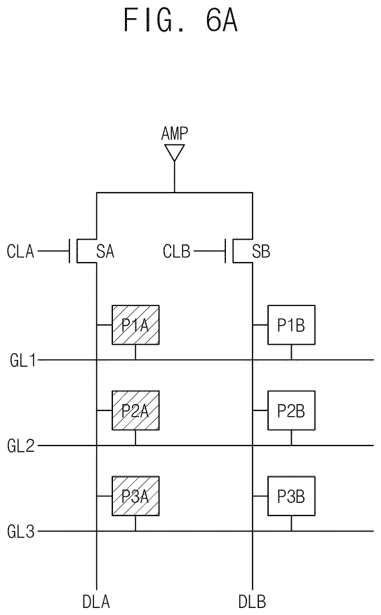

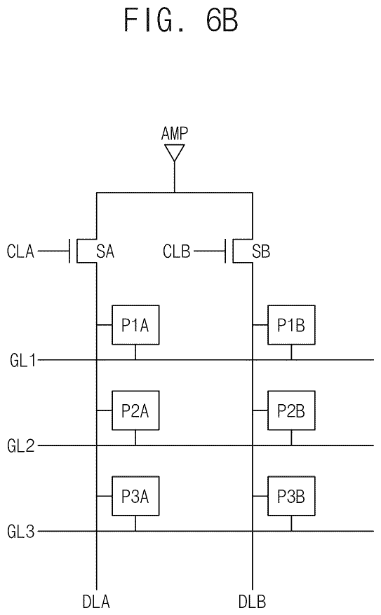

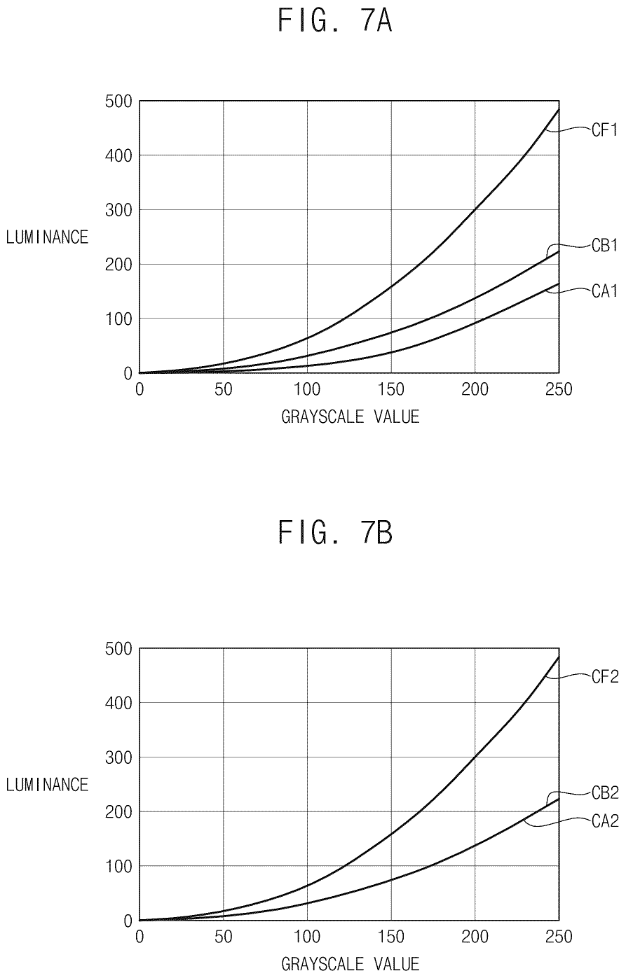

FIG. 4 is a block diagram illustrating the driving controller 200 of FIG. 1. FIG. 5A is a graph illustrating first output data DOUTA of FIG. 4 for first input data DINA of FIG. 4 for which a kickback compensation is desired. FIG. 5B is a graph illustrating second output data DOUTB of FIG. 4 for second input data DINB of FIG. 4 for which the kickback compensation is not desired. FIG. 6A is a circuit diagram illustrating the data driver 500 of FIG. 1, the display panel 100 of FIG. 1 and the demux circuit of FIG. 2 before the kickback compensation. FIG. 6B is a circuit diagram illustrating the data driver 500 of FIG. 1, the display panel 100 of FIG. 1 and the demux circuit of FIG. 2 after the kickback compensation. FIG. 7A is a graph illustrating a luminance of the display panel 100 of FIG. 1 according to grayscale values before the kickback compensation. FIG. 7B is a graph illustrating a luminance of the display panel 100 of FIG. 1 according to the grayscale values after the kickback compensation.

Referring to FIGS. 1 to 8, in an embodiment, the driving controller 200 compensates the difference of kickback of the input data DINA/DINB which is generated due to the demux switching of the demux circuit.

In an embodiment, for example, the driving controller 200 may determine a position (of pixels) corresponding to the input data DINA/DINB in the display panel 100. The driving controller 200 may compensate for the input data DINA of the pixel (e.g., PIA, P2A and P3A of FIG. 2) having a relatively high degree of the kickback based on the position. The driving controller 200 may not compensate for the input data DINB of the pixel (e.g., P1B, P2B and P3B of FIG. 2) having a relatively low degree of the kickback based on the position.

The driving controller 200 may include a position determiner 220 that receives first input data DINA and second input data DINB and determining a first position corresponding to the first input data DINA in the display panel 100 and a second position corresponding to the second input data DINA in the display panel 100, a kickback compensation lookup table 240 that receives the first input data DINA and outputting an offset value OS corresponding to the first input data DINA when a degree of kickback of a pixel in the first position is high, and an adder 260 that adds the first input data DINA and the offset value OS to generate the first output data DOUTA when the degree of kickback of the first position is high.

When a degree of kickback of a pixel in the second position is low, the driving controller 200 may output the second input data DINB as the second output data DOUTB.

In an embodiment, as shown in FIG. 5A, the first input data DINA and the offset value OSA, OSB and OSC may be added to generate the first output data DOUTA when the degree of kickback of the first position is high.

In an embodiment, as shown in FIG. 5A, the offset value OSA, OSB and OSC may vary according to a grayscale value of the first input data DINA.

In an embodiment, as shown in FIG. 5B, when the degree of kickback of the second position is low, the offset value may not be added to the second input data DINB such that the second output data DOUTB which is substantially the same as the second input data DINB may be generated. When the degree of kickback of the second position is low, the second input data DINB may bypass the kickback compensation lookup table 240 and the adder 260.

As described above and as shown in FIG. 6A, the degrees of kickback of the 1A pixel, the 2A pixel and the 3A pixel may be respectively greater than the degrees of kickback of the 1B pixel, the 2B pixel and the 3B pixel. Thus, when the difference of kickback is not compensated, the luminances of the 1A pixel, the 2A pixel and the 3A pixel may be respectively less than the luminances of the 1B pixel, the 2B pixel and the 3B pixel.

As shown in FIG. 4, the driving controller 200 may compensate the input data DINA of the pixel (e.g., PIA, P2A and P3A) having a relatively high degree of the kickback and not compensate the input data DINB of the pixel (e.g., P1B, P2B and P3B) having a relatively low degree of the kickback. Thus, as shown in FIG. 6B, the luminances of the 1A pixel, the 2A pixel and the 3A pixel may be compensated to be substantially the same as the luminances of the 1B pixel, the 2B pixel and the 3B pixel for a same grayscale value.

FIG. 7A represents a luminance according to the grayscale value before the kickback compensation and FIG. 7B represents a luminance according to the grayscale value after the kickback compensation.

In an embodiment, as shown in FIG. 7A, a target luminance CF1 for a full white image may be adjusted to 500 nit or candelas per square meter (cd/m²). A measured luminance CA1 when only the pixels (e.g., PIA, P2A and P3A) having the relatively high degree of the kickback are turned on may be less than a measured luminance CB1 when only the pixels (e.g., P1B, P2B and P3B) having the relatively low degree of the kickback are turned on.

In an embodiment, as shown in FIG. 7B, a target luminance CF1 for a full white image may be adjusted to 500 nit. A measured luminance CA2 when only the pixels (e.g., PIA, P2A and P3A) having the relatively high degree of the kickback are turned on may be adjusted substantially the same as a measured luminance CB2 when only the pixels (e.g., P1B, P2B and P3B) having the relatively low degree of the kickback are turned on.

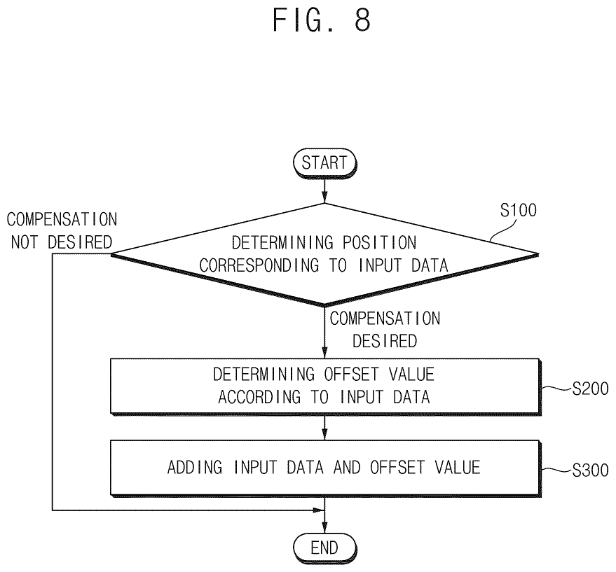

FIG. 8 is a flowchart illustrating an embodiment of a method of driving the display apparatus of FIG. 1.

In an embodiment, a driving method of the display apparatus may include compensating a difference of kickback of the input data DINA and DINB generated due to the demux switching of the demux circuit, generating the data voltage based on the output data DOUTA and DOUTB, in which the difference of kickback is compensated, and outputting the data voltage to the adjacent data lines of the display panel 100 using the demux circuit.

In an embodiment, for example, an operation of compensating the difference of kickback of the input data DINA and DINB may include determining the position in the display panel 100 (operation S100) corresponding to the input data DINA and DINB. In an embodiment, for example, in an operation of determining the position in the display panel 100 (operation S100), it may be determined that a degree of kickback of a position in the display panel 100 is great (PIA, P2A and P3A of FIG. 2) or little (PIB, P2B and P3B of FIG. 2). The operation of compensating the difference of kickback of the input data DINA

and DINB may further include determining the offset value OS (operation S200) corresponding to the input data DINA and DINB when it is determined that a compensation of the input data is desired (or to be performed) and adding the input data DINA and DINB and the offset value OS (operation S300) when it is determined that the compensation of the input data is desired (or to be performed).

According to an embodiment, the display apparatus may include the demux circuit that alternately outputs the data voltages to the adjacent data lines DLA and DLB such that a number of the output amplifiers AMP of the data driver 500 may be reduced. Thus, a manufacturing cost of the display apparatus may be reduced.

In such an embodiment, a difference of degrees of kickback of the input data generated due to the demux switching of the demux circuit may be compensated such that a display quality of the display panel 100 may be enhanced.

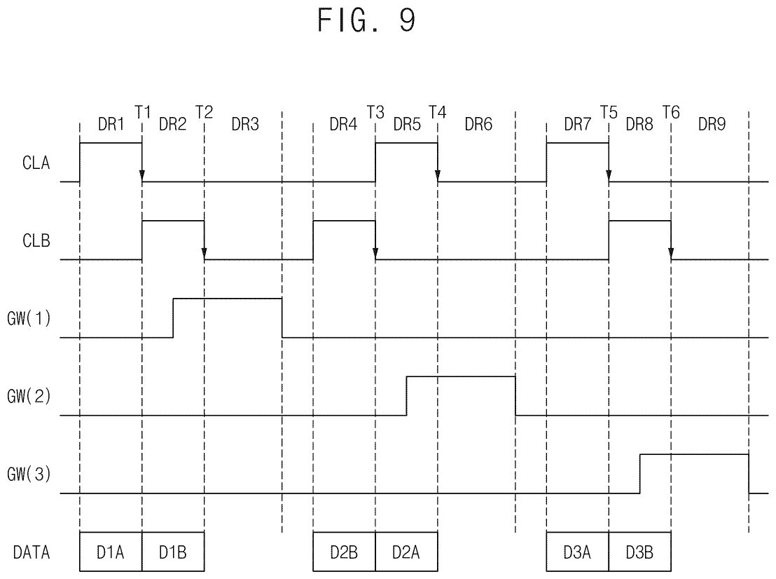

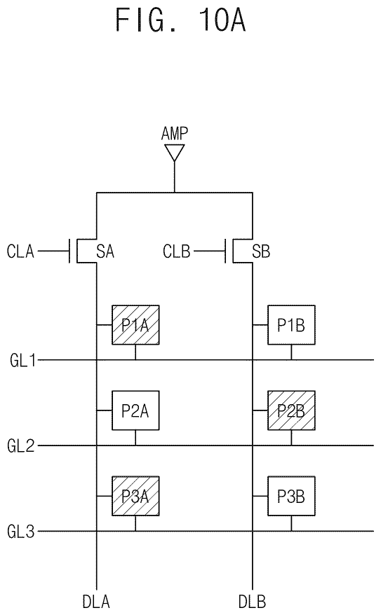

FIG. 9 is a signal timing diagram illustrating a switching signal CLA and CLB applied to a demux circuit of a display apparatus according to an embodiment of the invention, a gate signal GW(1), GW(2) and GW(3) and a data voltage D1A, D1B, D2A, D2B, D3A and

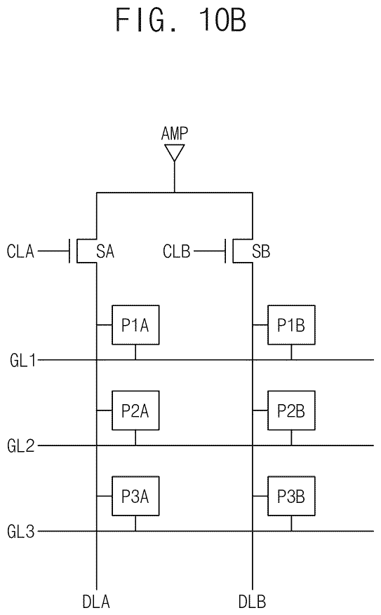

D3B which are applied to a display panel 100. FIG. 10A is a circuit diagram illustrating a data driver 500, the display panel 100 and the demux circuit of the display apparatus of FIG. 9 before a kickback compensation. FIG. 10B is a circuit diagram illustrating the data driver 500, the display panel 100 and the demux circuit of the display apparatus of FIG. 9 after the kickback compensation.

The display apparatus according to the embodiment shown in FIGS. 9 to 10B is substantially the same as the display apparatus of the embodiment described above referring to FIGS. 1 to 8 except for orders of applying switching signals CLA and CLB and data voltages D1A, D1B, D2A, D2B, D3A and D3B. Thus, the same reference numerals will be used to refer to the same or like parts as those described above referring to FIGS. 1 to 8 and any repetitive detailed description thereof will be omitted.

Referring to FIGS. 1, 2, 4, 5A, 5B and 7A to 10B, in an embodiment, the demux circuit may alternately output the data voltages to the adjacent data lines of the display panel 100.

The data driver 500 may include an output amplifier AMP that outputs the data voltage.

The demux circuit may include a first switch SA connected to the output amplifier AMP and activated in response to a first switching signal CLA and a second switch SB connected to the output amplifier AMP and activated in response to a second switching signal CLB.

The display panel 100 may include a first gate line GL1 that applies a first gate signal applies a third gate signal GW3, a first data line DLA connected to the first switch SA, a second data line DLB connected to the second switch SB, an 1A pixel PIA connected to the first gate line GL1 and the first data line DLA, an 1B pixel PIB connected to the first gate line GL1 and the second data line DLB, a 2A pixel P2A connected to the second gate line GL2 and the first data line DLA, a 2B pixel P2B connected to the second gate line GL2 and the second data line DLB, a 3A pixel P3A connected to the third gate line GL3 and the first data line DLA and a 3B pixel P3B connected to the third gate line GL3 and the second data line DLB.

In an embodiment, as shown in FIG. 9, the first switching signal CLA may have an active level in a first period DR1, the second switching signal CLB may have an inactive level in the first period DR1, the first gate signal GW(1) may have an inactive level in the first period DR1, the second gate signal GW(2) may have an inactive level in the first period DR1, the third gate signal GW(3) may have an inactive level in the first period DR1 and the data voltage may be an 1A data voltage D1A corresponding to the 1A pixel PIA. The first switching signal CLA may have an inactive level in a second period DR2 subsequent to the first period DR1, the second switching signal CLB may have an active level in the second period DR2, the first gate signal GW(1) may sequentially have the inactive level and an active level in the second period DR2, the second gate signal GW(2) may have the inactive level in the second period DR2, the third gate signal GW(3) may have the inactive level in the second period DR2 and the data voltage may be an 1B data voltage D1B corresponding to the 1B pixel PIB. The first switching signal CLA may have the inactive level in a third period DR3 subsequent to the second period DR2, the second switching signal CLB may have the inactive level in the third period DR3, the first gate signal GW(1) may maintain the active level in the third period DR3, the second gate signal GW(2) may have the inactive level in the third period DR3 and the third gate signal GW(3) may have the inactive level in the third period DR3. The first switching signal CLA may have the inactive level in a fourth period DR4 subsequent to the third period DR3, the second switching signal CLB may have the active level in the fourth period DR4, the first gate signal GW(1) may have the inactive level in the fourth period DR4, the second gate signal GW(2) may have the inactive level in the fourth period DR4, the third gate signal GW(3) may have the inactive level in the fourth period DR4 and the data voltage may be a 2B data voltage D2B corresponding to the 2B pixel P2B. The first switching signal CLA may have the active level in a fifth period DR5 subsequent to the fourth period DR4, the second switching signal CLB may have the inactive level in the fifth period DR5, the first gate signal GW(1) may have the inactive level in the fifth period DR5, the second gate signal GW(2) may sequentially have the inactive level and an active level in the fifth period DR5, the third gate signal GW(3) may have the inactive level in the fifth period DR5 and the data voltage may be a 2A data voltage D2A corresponding to the 2A pixel P2A. The first switching signal CLA may have the inactive level in a sixth period DR6 subsequent to the fifth period DR5, the second switching signal CLB may have the inactive level in the sixth period DR6, the first gate signal GW(1) may have the inactive level in the sixth period DR6, the second gate signal GW(2) may maintain the active level in the sixth period DR6 and the third gate signal GW(3) may have the inactive level in the sixth period DR6. The first switching signal CLA may have the active level in a seventh period DR7 subsequent to the sixth period DR6, the second switching signal CLB may have the inactive level in the seventh period DR7, the first gate signal GW(1) may have the inactive level in the seventh period DR7, the second gate signal GW(2) may have the inactive level in the seventh period DR7, the third gate signal GW(3) may have the inactive level in the seventh period DR7 and the data voltage may be a 3A data voltage D3A corresponding to the 3A pixel P3A. The first switching signal CLA may have the inactive level in an eighth period DR8 subsequent to the seventh period DR7, the second switching signal CLB may have the active level in the eighth period DR8, the first gate signal GW(1) may have the inactive level in the eighth period DR8, the second gate signal GW(2) may have the inactive level in the eighth period DR8, the third gate signal GW(3) may sequentially have the inactive level and an active level in the eighth period DR8 and the data voltage may be a 3B data voltage D3B corresponding to the 3B pixel P3B. The first switching signal CLA may have the inactive level in a ninth period DR9 subsequent to the eighth period DR8, the second switching signal CLB may have the inactive level in the ninth period DR9, the first gate signal GW(1) may have the inactive level in the ninth period DR9, the second gate signal GW(2) may have the inactive level in the ninth period DR9 and the third gate signal GW(3) may maintain the active level in the ninth period DR9.

Such an embodiment represents a case that the first switching signal CLA and the second switching signal CLB alternates in a unit of two data instead of one datum.

Thus, in such an embodiment, a degree of kickback of the 1A pixel PIA may be greater than a degree of kickback of the 1B pixel PIB, a degree of kickback of the 2B pixel P2B may be greater than a degree of kickback of the 2A pixel P2A and a degree of kickback of the 3A pixel P3A may be greater than a degree of kickback of the 3B pixel P3B.

The driving controller 200 compensates the difference of kickback of the input data DINA/DINB which is generated due to the demux switching of the demux circuit.

In an embodiment, for example, the driving controller 200 may determine a position in the display panel 100 corresponding to the input data DINA/DINB. The driving controller 200 may compensate for the input data DINA of the pixel (e.g., PIA, P2B and P3A of FIG. 2) having a relatively high degree of the kickback based on the position. The driving controller 200 may not compensate for the input data DINB of the pixel (e.g., PIB, P2A and P3B of FIG. 2) having a relatively low degree of the kickback based on the position.

According to an embodiment, the display apparatus may include the demux circuit that alternately outputs the data voltages to the adjacent data lines DLA and DLB such that a number of the output amplifiers AMP of the data driver 500 may be reduced. Thus, a manufacturing cost of the display apparatus may be reduced.

In such an embodiment, a difference of degrees of kickback of the input data generated due to the demux switching of the demux circuit may be compensated such that a display quality of the display panel 100 may be enhanced.

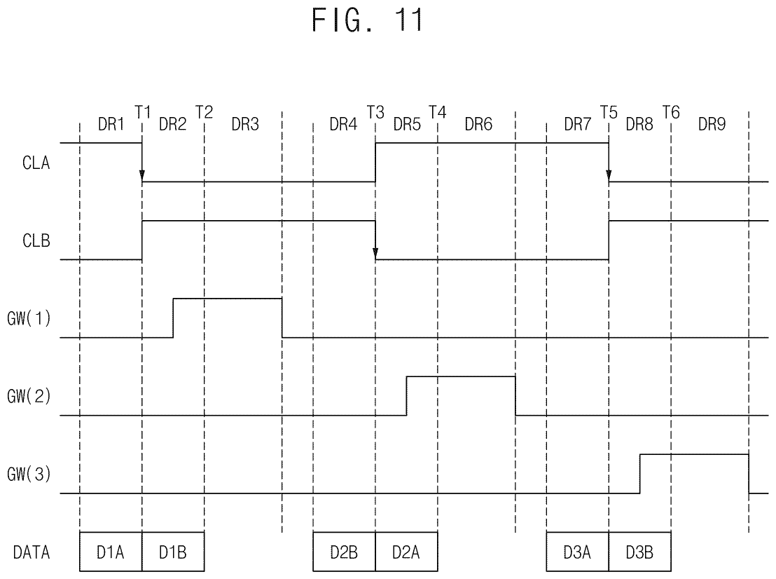

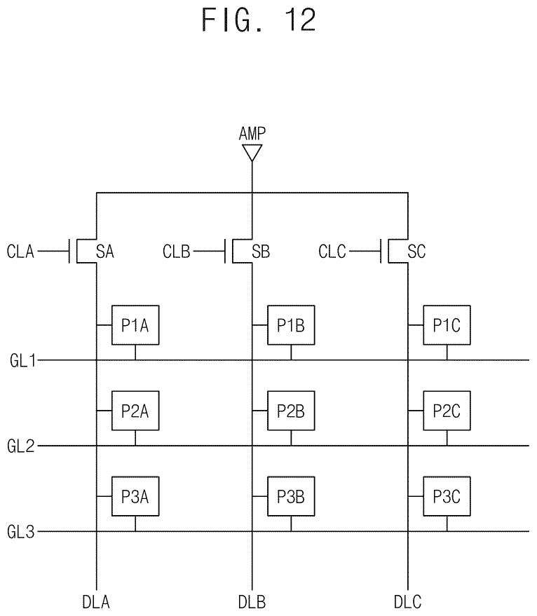

FIG. 11 is a signal timing diagram illustrating a switching signal CLA and CLB applied to a demux circuit of a display apparatus according to an embodiment of the invention, a gate signal GW(1), GW(2) and GW(3) and a data voltage D1A, D1B, D2A, D2B, D3A and D3B which are applied to a display panel.

The display apparatus according to the embodiment shown in FIG. 11 is substantially the same as the display apparatus of the embodiment described above referring to FIGS. 1 to 8 except for orders of applying switching signals CLA and CLB and data voltages D1A, D1B, D2A, D2B, D3A and D3B. Thus, the same reference numerals will be used to refer to the same or like parts as those described above referring to FIGS. 1 to 8 and any repetitive detailed description thereof will be omitted.

Referring to FIGS. 1, 2, 4, 5A, 5B, 7A to 8 and 10A to 11, in an embodiment, the demux circuit may alternately output the data voltages to the adjacent data lines of the display panel 100.

The data driver 500 may include an output amplifier AMP that outputs the data voltage.

The demux circuit may include a first switch SA connected to the output amplifier AMP and activated in response to a first switching signal CLA and a second switch SB connected to the output amplifier AMP and activated in response to a second switching signal CLB.

The display panel 100 may include a first gate line GL1 that applies a first gate signal applies a third gate signal GW3, a first data line DLA connected to the first switch SA, a second data line DLB connected to the second switch SB, an 1A pixel PIA connected to the first gate line GL1 and the first data line DLA, an 1B pixel PIB connected to the first gate line GL1 and the second data line DLB, a 2A pixel P2A connected to the second gate line GL2 and the first data line DLA, a 2B pixel P2B connected to the second gate line GL2 and the second data line DLB, a 3A pixel P3A connected to the third gate line GL3 and the first data line DLA and a 3B pixel P3B connected to the third gate line GL3 and the second data line DLB.

In an embodiment, as shown in FIG. 11, the first switching signal CLA may have an active level in a first period DR1, the second switching signal CLB may have an inactive level in the first period DR1, the first gate signal GW(1) may have an inactive level in the first period DR1, the second gate signal GW(2) may have an inactive level in the first period DR1, the third gate signal GW(3) may have an inactive level in the first period DR1 and the data voltage may be an 1A data voltage D1A corresponding to the 1A pixel PIA. The first switching signal CLA may have an inactive level in a second period DR2 subsequent to the first period DR1, the second switching signal CLB may have an active level in the second period DR2, the first gate signal GW(1) may sequentially have the inactive level and an active level in the second period DR2, the second gate signal GW(2) may have the inactive level in the second period DR2, the third gate signal GW(3) may have the inactive level in the second period DR2 and the data voltage may be an 1B data voltage D1B corresponding to the 1B pixel PIB. The first switching signal CLA may have the inactive level in a third period DR3 subsequent to the second period DR2, the second switching signal CLB may have the active level in the third period DR3, the first gate signal GW(1) may maintain the active level in the third period DR3, the second gate signal GW(2) may have the inactive level in the third period DR3 and the third gate signal GW(3) may have the inactive level in the third period DR3. The first switching signal CLA may have the inactive level in a fourth period DR4 subsequent to the third period DR3, the second switching signal CLB may have the active level in the fourth period DR4, the first gate signal GW(1) may have the inactive level in the fourth period DR4, the second gate signal GW(2) may have the inactive level in the fourth period DR4, the third gate signal GW(3) may have the inactive level in the fourth period DR4 and the data voltage may be a 2B data voltage D2B corresponding to the 2B pixel P2B. The first switching signal CLA may have the active level in a fifth period DR5 subsequent to the fourth period DR4, the second switching signal CLB may have the inactive level in the fifth period DR5, the first gate signal GW(1) may have the inactive level in the fifth period DR5, the second gate signal GW(2) may sequentially have the inactive level and an active level in the fifth period DR5, the third gate signal GW(3) may have the inactive level in the fifth period DR5 and the data voltage may be a 2A data voltage D2A corresponding to the 2A pixel P2A. The first switching signal CLA may have the active level in a sixth period DR6 subsequent to the fifth period DR5, the second switching signal CLB may have the inactive level in the sixth period DR6, the first gate signal GW(1) may have the inactive level in the sixth period DR6, the second gate signal GW(2) may maintain the active level in the sixth period DR6 and the third gate signal GW(3) may have the inactive level in the sixth period DR6. The first switching signal CLA may have the active level in a seventh period DR7 subsequent to the sixth period DR6, the second switching signal CLB may have the inactive level in the seventh period DR7, the first gate signal GW(1) may have the inactive level in the seventh period DR7, the second gate signal GW(2) may have the inactive level in the seventh period DR7, the third gate signal GW(3) may have the inactive level in the seventh period DR7 and the data voltage may be a 3A data voltage D3A corresponding to the 3A pixel P3A. The first switching signal CLA may have the inactive level in an eighth period DR8 subsequent to the seventh period DR7, the second switching signal CLB may have the active level in the eighth period DR8, the first gate signal GW(1) may have the inactive level in the eighth period DR8, the second gate signal GW(2) may have the inactive level in the eighth period DR8, the third gate signal GW(3) may sequentially have the inactive level and an active level in the eighth period DR8 and the data voltage may be a 3B data voltage D3B corresponding to the 3B pixel P3B. The first switching signal CLA may have the inactive level in a ninth period DR9 subsequent to the eighth period DR8, the second switching signal CLB may have the inactive level in the ninth period DR9, the first gate signal GW(1) may have the inactive level in the ninth period DR9, the second gate signal GW(2) may have the inactive level in the ninth period DR9 and the third gate signal GW(3) may maintain the active level in the ninth period DR9.

Such an embodiment represents a case that the first switching signal CLA and the second switching signal CLB alternates in a unit of two data instead of one datum.

Thus, in such an embodiment, a degree of kickback of the 1A pixel PIA may be greater than a degree of kickback of the 1B pixel PIB, a degree of kickback of the 2B pixel P2B may be greater than a degree of kickback of the 2A pixel P2A and a degree of kickback of the 3A pixel P3A may be greater than a degree of kickback of the 3B pixel P3B.

In addition, in such an embodiment, the second switching signal CLB maintains the active level in the third period DR3 and the first switching signal CLA maintains the active level in the sixth period DR6. Accordingly, a number of togglings of the first switching signal CLA and a number of togglings of the second switching signal CLB may be reduced compared to the previous embodiment of FIG. 9 such that a power consumption of the display apparatus may be reduced.

The driving controller 200 compensates the difference of kickback of the input data DINA/DINB which is generated due to the demux switching of the demux circuit.

In an embodiment, for example, the driving controller 200 may determine a position in the display panel 100 corresponding to the input data DINA/DINB. The driving controller 200 may compensate for the input data DINA of the pixel (e.g., PIA, P2B and P3A of FIG. 2) having a relatively high degree of the kickback based on the position. The driving controller 200 may not compensate for the input data DINB of the pixel (e.g., PIB, P2A and P3B of FIG. 2) having a relatively low degree of the kickback based on the position.

According to an embodiment, the display apparatus may include the demux circuit that alternately outputs the data voltages to the adjacent data lines DLA and DLB such that a number of the output amplifiers AMP of the data driver 500 may be reduced. Thus, a manufacturing cost of the display apparatus may be reduced.

In such an embodiment, a difference of degrees of kickback of the input data generated due to the demux switching of the demux circuit may be compensated such that a display quality of the display panel 100 may be enhanced.

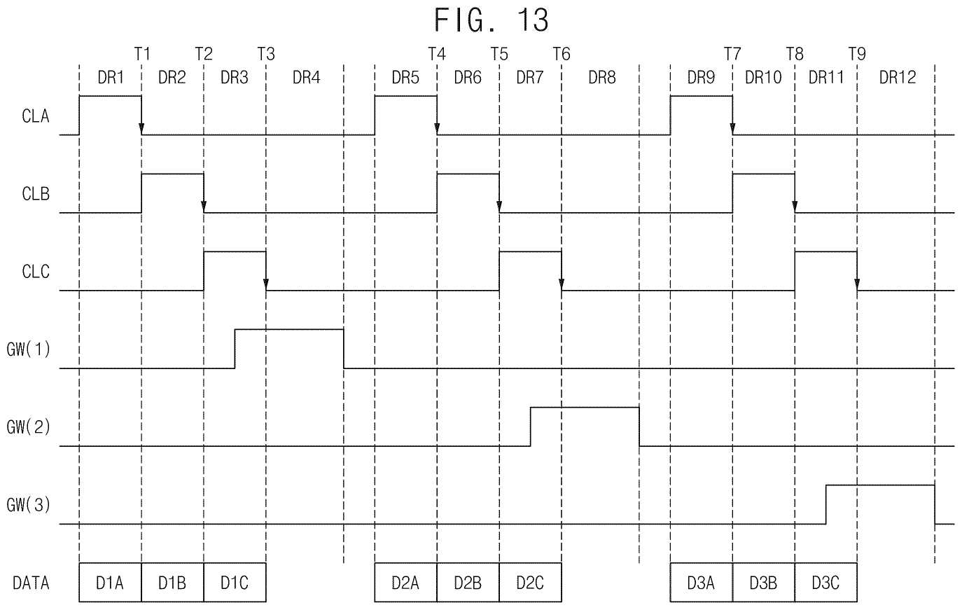

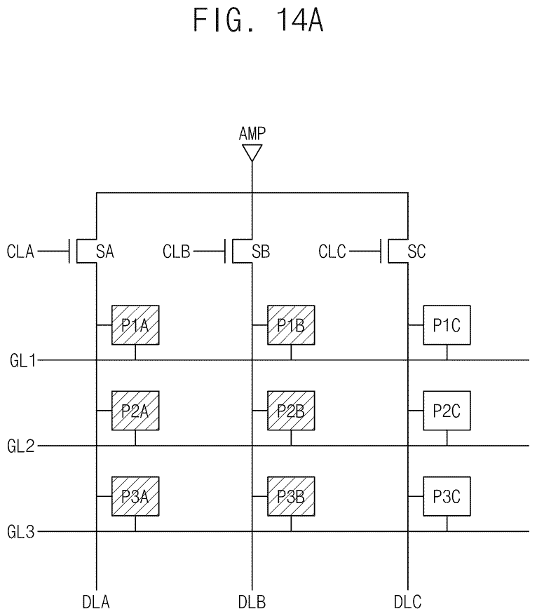

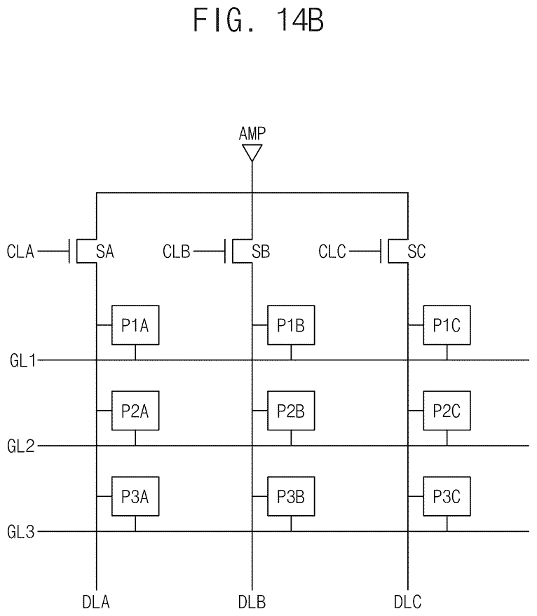

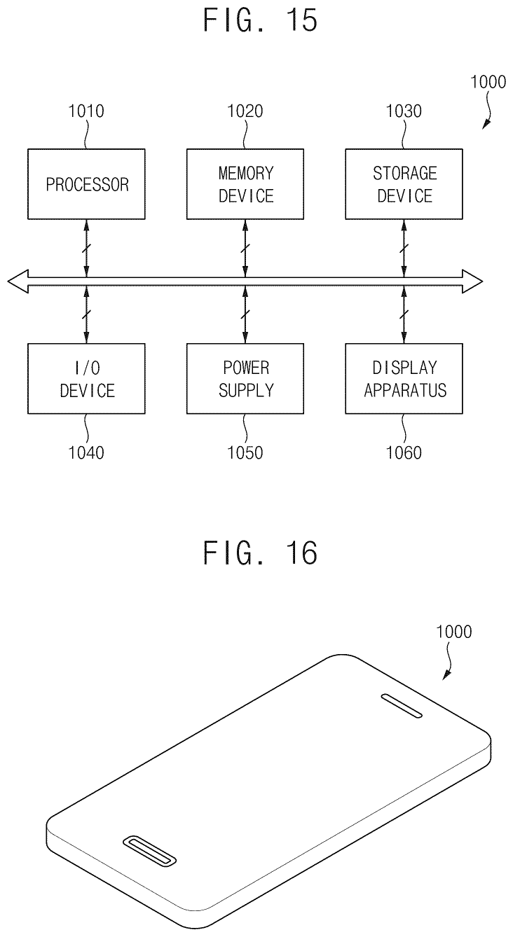

FIG. 12 is a circuit diagram illustrating a data driver 500, a display panel 100 and a demux circuit of a display apparatus according to an embodiment of the invention. FIG. 13 is a signal timing diagram illustrating a switching signal CLA and CLB applied to the demux circuit of the display apparatus of FIG. 12, a gate signal GW(1), GW(2) and GW(3) and a data voltage D1A, D1B, D1C, D2A, D2B, D2C, D3A, D3B and D3C which are applied to a display panel of the display apparatus of FIG. 12. FIG. 14A is a circuit diagram illustrating the data driver 500, the display panel 100 and the demux circuit of the display apparatus of FIG. 12 before a kickback compensation. FIG. 14B is a circuit diagram illustrating the data driver 500, the display panel 100 and the demux circuit of the display apparatus of FIG. 12 after the kickback compensation.

The display apparatus according to the embodiment shown in FIGS. 12 to 14B is substantially the same as the display apparatus of the embodiment described above referring to FIGS. 1 to 8 except that three adjacent data lines are connected to one output amplifier in the demux circuit. Thus, the same reference numerals will be used to refer to the same or like parts as those described above referring to FIGS. 1 to 8 and any repetitive detailed description thereof will be omitted.

Referring to FIGS. 1, 4, 5A, 5B, 7A to 8, 12, 13, 14A and 14B, in an embodiment, the demux circuit may alternately output the data voltages to the adjacent data lines of the display panel 100.

The data driver 500 may include an output amplifier AMP that outputs the data voltage.

The demux circuit may include a first switch SA connected to the output amplifier AMP and activated in response to a first switching signal CLA, a second switch SB connected to the output amplifier AMP and activated in response to a second switching signal CLB and a third switch SC connected to the output amplifier AMP and activated in response to a third switching signal CLC.

The display panel 100 may include a first gate line GL1 that applies a first gate signal GW1, a second gate line GL2 that applies a second gate signal GW2, a third gate line GL3 that applies a third gate signal GW3, a first data line DLA connected to the first switch SA, a second data line DLB connected to the second switch SB, a third data line DLC connected to the third switch SC, an 1A pixel PIA connected to the first gate line GL1 and the first data line DLA, an 1B pixel PIB connected to the first gate line GL1 and the second data line DLB, an 1C pixel PIC connected to the first gate line GL1 and the third data line DLC, a 2A pixel P2A connected to the second gate line GL2 and the first data line DLA, a 2B pixel P2B connected to the second gate line GL2 and the second data line DLB, a 2C pixel P2C connected to the second gate line GL2 and the third data line DLC, a 3A pixel P3A connected to the third gate line GL3 and the first data line DLA, a 3B pixel P3B connected to the third gate line GL3 and the second data line DLB and a 3C pixel P3C connected to the third gate line GL3 and the third data line DLC.

In an embodiment, as shown in FIG. 13, the first switching signal CLA may have an active level in a first period DR1, the second switching signal CLB may have an inactive level in the first period DR1, the third switching signal CLC may have an inactive level in the first period DR1, the first gate signal GW(1) may have an inactive level in the first period DR1, the second gate signal GW(2) may have an inactive level in the first period DR1, the third gate signal GW(3) may have an inactive level in the first period DR1 and the data voltage may be an 1A data voltage D1A corresponding to the 1A pixel PIA. The first switching signal CLA may have an inactive level in a second period DR2 subsequent to the first period DR1, the second switching signal CLB may have an active level in the second period DR2, the third switching signal CLC may have the inactive level in the second period DR2, the first gate signal GW(1) may have the inactive level in the second period DR2, the second gate signal GW(2) may have the inactive level in the second period DR2, the third gate signal GW(3) may have the inactive level in the second period DR2 and the data voltage may be an 1B data voltage D1B corresponding to the 1B pixel PIB. The first switching signal CLA may have the inactive level in a third period DR3 subsequent to the second period DR2, the second switching signal CLB may have the inactive level in the third period DR3, the third switching signal CLC may have an active level in the third period DR3, the first gate signal GW(1) may sequentially have the inactive level and an active level in the third period DR3, the second gate signal GW(2) may have the inactive level in the third period DR3, the third gate signal GW(3) may have the inactive level in the third period DR3 and the data voltage may be an 1C data voltage D1C corresponding to the 1C pixel PIC. The first switching signal CLA may have the inactive level in a fourth period DR4 subsequent to the third period DR3, the second switching signal CLB may have the inactive level in the fourth period DR4, the third switching signal CLC may have the inactive level in the fourth period DR4, the first gate signal GW(1) may maintain the active level in the fourth period DR4, the second gate signal GW(2) may have the inactive level in the fourth period DR4 and the third gate signal GW(3) may have the inactive level in the fourth period DR4. The first switching signal CLA may have the active level in a fifth period DR5 subsequent to the fourth period DR4, the second switching signal CLB may have the inactive level in the fifth period DR5, the third switching signal CLC may have the inactive level in the fifth period DR5, the first gate signal GW(1) may have the inactive level in the fifth period DR5, the second gate signal GW(2) may have the inactive level in the fifth period DR5, the third gate signal GW(3) may have the inactive level in the fifth period DR5 and the data voltage may be a 2A data voltage D2A corresponding to the 2A pixel P2A. The first switching signal CLA may have the inactive level in a sixth period DR6 subsequent to the fifth period DR5, the second switching signal CLB may have the active level in the sixth period DR6, the third switching signal CLC may have the inactive level in the sixth period DR6, the first gate signal GW(1) may have the inactive level in the sixth period DR6, the second gate signal GW(2) may have the inactive level in the sixth period DR6, the third gate signal GW(3) may have the inactive level in the sixth period DR6 and the data voltage may be a 2B data voltage D2B corresponding to the 2B pixel P2B. The first switching signal CLA may have the inactive level in a seventh period DR7 subsequent to the sixth period DR6, the second switching signal CLB may have the inactive level in the seventh period DR7, the third switching signal CLC may have the active level in the seventh period DR7, the first gate signal GW(1) may have the inactive level in the seventh period DR7, the second gate signal GW(2) may sequentially have the inactive level and an active level in the seventh period DR7, the third gate signal GW(3) may have the inactive level in the seventh period DR7 and the data voltage may be a 2C data voltage D2C corresponding to the 2C pixel P2C. The first switching signal CLA may have the inactive level in an eighth period DR8 subsequent to the seventh period DR7, the second switching signal CLB may have the inactive level in the eighth period DR8, the third switching signal CLC may have the inactive level in the eighth period DR8, the first gate signal GW(1) may have the inactive level in the eighth period DR8, the second gate signal GW(2) may maintain the active level in the eighth period DR8 and the third gate signal GW(3) may have the inactive level in the eighth period DR8. The first switching signal CLA may have the active level in a ninth period DR9 subsequent to the eighth period DR8, the second switching signal CLB may have the inactive level in the ninth period DR9, the third switching signal CLC may have the inactive level in the ninth period DR9, the first gate signal GW(1) may have the inactive level in the ninth period DR9, the second gate signal GW(2) may have the inactive level in the ninth period DR9, the third gate signal GW(3) may have the inactive level in the ninth period DR9 and the data voltage may be a 3A data voltage D3A corresponding to the 3A pixel P3A. The first switching signal CLA may have the inactive level in a tenth period DR10 subsequent to the ninth period DR9, the second switching signal CLB may have the active level in the tenth period DR10, the third switching signal CLC may have the inactive level in the tenth period DR10, the first gate signal GW(1) may have the inactive level in the tenth period DR10, the second gate signal GW(2) may have the inactive level in the tenth period DR10, the third gate signal GW(3) may have the inactive level in the tenth period DR10 and the data voltage may be a 3B data voltage D3B corresponding to the 3B pixel P3B. The first switching signal CLA may have the inactive level in an eleventh period DR11 subsequent to the tenth period DR10, the second switching signal CLB may have the inactive level in the eleventh period DR11, the third switching signal CLC may have the active level in the eleventh period DR11, the first gate signal GW(1) may have the inactive level in the eleventh period DR11, the second gate signal GW(2) may have the inactive level in the eleventh period DR11, the third gate signal GW(3) may sequentially have the inactive level and an active level in the eleventh period DR11 and the data voltage may be a 3C data voltage D3C corresponding to the 3C pixel P3C. The first switching signal CLA may have the inactive level in a twelfth period DR12 subsequent to the eleventh period DR11, the second switching signal CLB may have the inactive level in the twelfth period DR12, the third switching signal CLC may have the inactive level in the twelfth period DR12, the first gate signal GW(1) may have the inactive level in the twelfth period DR12, the second gate signal GW(2) may have the inactive level in the twelfth period DR12 and the third gate signal GW(3) may maintain the active level in the twelfth period DR12.

In such embodiment, a degree of kickback of the 1A pixel PIA and a degree of kickback of the 1B pixel PIB may be greater than a degree of kickback of the 1C pixel PIC. A degree of kickback of the 2A pixel P2A and a degree of kickback of the 2B pixel P2B may be greater than a degree of kickback of the 2C pixel P2C. A degree of kickback of the 3A pixel P3A and a degree of kickback of the 3B pixel P3B may be greater than a degree of kickback of the 3C pixel P3C.

The driving controller 200 compensates the difference of kickback of the input data DINA/DINB which is generated due to the demux switching of the demux circuit.

In an embodiment, for example, the driving controller 200 may determine a position in the display panel 100 corresponding to the input data DINA/DINB. The driving controller 200 may compensate for the input data DINA of the pixel (e.g., P1A, P1B, P2A, P2B, P3A and P3B of FIG. 12) having a relatively high degree of the kickback based on the position. The driving controller 200 may not compensate for the input data DINB of the pixel (e.g., PIC, P2C and P3C of FIG. 12) having a relatively low degree of the kickback based on the position. According to an embodiment, the display apparatus may include the demux circuit

that alternately outputs the data voltages to the adjacent data lines DLA, DLB and DLC so that a number of the output amplifiers AMP of the data driver 500 may be reduced. Thus, a manufacturing cost of the display apparatus may be reduced.

In such an embodiment, a difference of degrees of kickback of the input data generated due to the demux switching of the demux circuit may be compensated such that a display quality of the display panel 100 may be enhanced.

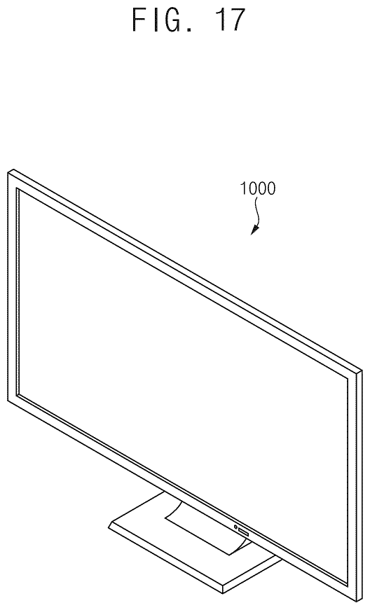

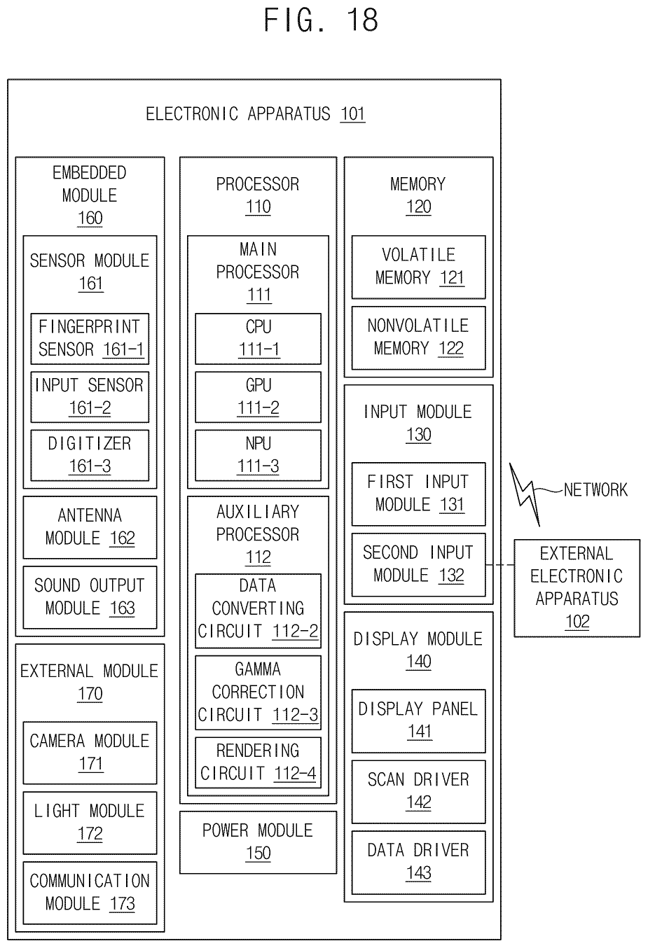

FIG. 15 is a block diagram illustrating an electronic apparatus 1000 according to an embodiment of the invention. FIG. 16 is a diagram illustrating an embodiment in which the electronic apparatus 1000 of FIG. 15 is implemented as a smartphone. FIG. 17 is a diagram illustrating an embodiment in which the electronic apparatus 1000 of FIG. 15 is implemented as a monitor.

Referring to FIGS. 15 to 17, an embodiment of the electronic apparatus 1000 may include a processor 1010, a memory device 1020, a storage device 1030, an input/output (I/O) device 1040, a power supply 1050, and a display apparatus 1060. Here, the display apparatus 1060 may correspond to the display apparatus of FIG. 1. In addition, the electronic apparatus 1000 may further include a plurality of ports for communicating with a video card, a sound card, a memory card, a universal serial bus (USB) device, other electronic apparatuses, etc.

In an embodiment, as illustrated in FIG. 16, the electronic apparatus 1000 may be implemented as a smartphone. In an embodiment, as illustrated in FIG. 17, the electronic apparatus 1000 may be implemented as a monitor. However, the electronic apparatus 1000 is not limited thereto. In an embodiment, for example, the electronic apparatus 1000 may be implemented as a television, a cellular phone, a video phone, a smart pad, a smart watch, a tablet personal computer (PC), a car navigation system, a laptop, a head mounted display (HMD) device, or the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

FIG. 18 is a block diagram illustrating an electronic apparatus 101 according to an embodiment of the invention.

Referring to FIGS. 1 to 18, an embodiment of an electronic apparatus 101 outputs various information through a display module 140 in an operating system. When a processor 110 executes an application stored in a memory 120, the display module 140 provides application information to a user through a display panel 141.

The processor 110 obtains an external input through an input module 130 or a sensor module 161 and executes an application corresponding to the external input. For example, when the user selects a camera icon displayed on the display panel 141, the processor 110 obtains a user input through an input sensor 161-2 and activates a camera module 171. The processor 110 transfers image data corresponding to a captured image obtained through the camera module 171 to the display module 140. The display module 140 may display an image corresponding to the captured image through the display panel 141.

In an embodiment, when a personal information authentication is executed in the display module 140, a fingerprint sensor 161-1 obtains input fingerprint information as input data. The processor 110 compares input data obtained through the fingerprint sensor 161-1 with authentication data stored in the memory 120, and executes an application according to a comparison result. The display module 140 may display information executed according to application logic through the display panel 141.

In an embodiment, when a music streaming icon displayed on the display module 140 is selected, the processor 110 obtains a user input through the input sensor 161-2 and activates a music streaming application stored in the memory 120. When a music execution command is input in the music streaming application, the processor 110 activates a sound output module 163 to provide sound information corresponding to the music execution command to the user.

In the above, the operation of the electronic apparatus 101 is briefly described. Hereinafter, a configuration of the electronic apparatus 101 will be described in detail. Some of elements of the electronic apparatus 101 described later may be integrated and provided as one element, or one element may be separated as two or more elements.

The electronic apparatus 101 may communicate with an external electronic apparatus 102 through a network (e.g., a short-range wireless communication network or a long-range wireless communication network). According to an embodiment, the electronic apparatus 101 may include the processor 110, the memory 120, the input module 130, the display module 140, a power module 150, an embedded module 160, and an external module 170. According to an embodiment, in the electronic apparatus 101, at least one of the above-described elements may be omitted or one or more other apparatus may be added. According to an embodiment, some of the above-described elements (e.g., the sensor module 161, an antenna module 162 or the sound output module 163) may be integrated into another element (e.g., the display module 140).

The processor 110 may execute software to control at least one other element (e.g., hardware or software element) of the electronic apparatus 101 connected to the processor 110 and to perform various data processing or operations. According to an embodiment, as at least part of the data processing or the operations, the processor 110 may store receive instructions or data from other elements (e.g., the input module 130, the sensor module 161 or a communication module 173) in a volatile memory 121, may process the instructions or data stored in the volatile memory 121 and may store result data of the processing in a nonvolatile memory 122.

The processor 110 may include a main processor 111 and an auxiliary processor 112. The main processor 111 may include at least one selected from a central processing unit (CPU) 111-1 and an application processor (AP). The main processor 111 may further include least one selected from a graphic processing unit (GPU) 111-2, a communication processor (CP) and an image signal processor (ISP). The main processor 111 may further include a neural processing unit (NPU) 111-3. The neural network processing unit 111-3 is a processor specialized in processing an artificial intelligence model. The artificial intelligence model may be generated through a machine learning. The artificial intelligence model may include a plurality of artificial neural network layers. The artificial neural network may be one of a deep neural network (DNN), a convolutional neural network (CNN), a recurrent neural network (RNN), a restricted boltzmann machine (RBM), a deep belief network (DBN), a bidirectional recurrent deep neural network (BRDNN) and a deep Q-networks or a combination of two or more of the above. However, the artificial neural network is not limited to the above examples. The artificial intelligence model may include software structures, in addition to hardware structures or instead of the hardware structures. At least two of the above-described processing units and the above-described processors may be implemented as an integrated element (e.g., a single chip) or each may be implemented as independent elements (e.g., in a plurality of chips).

The auxiliary processor 112 may include a controller. The controller may include an interface conversion circuit and a timing control circuit. The controller receives an image signal from the main processor 111, converts a data format of the image signal to meet interface specifications with the display module 140, and outputs image data. The controller may output various control signals for driving the display module 140.

The auxiliary processor 112 may further include a data converting circuit 112-2, a gamma correction circuit 112-3 and a rendering circuit 112-4. The data converting circuit 112-2 may receive the image data from the controller and may compensate the image data such that the image is displayed with a desired luminance according to characteristics of the electronic apparatus 101 or a user setting or may convert the image data to reduce a power consumption or compensate for afterimages. The gamma correction circuit 112-3 may convert the image data or a gamma reference voltage such that the image displayed on the electronic apparatus 101 has desired gamma characteristics. The rendering circuit 112-4 may receive the image data from the controller and may render the image data based on a pixel arrangement of the display panel 141 included in the electronic apparatus 101. At least one of the data converting circuit 112-2, the gamma correction circuit 112-3 and the rendering circuit 112-4 may be integrated into another element (e.g., the main processor 111 or the controller). At least one of the data converting circuit 112-2, the gamma correction circuit 112-3 and the rendering circuit 112-4 may be integrated into a data driver 143 to be described later.

The memory 120 may store various data used by at least one element (e.g., the processor 110 or the sensor module 161) of the electronic apparatus 101 and input data or output data for commands related thereto. The memory 120 may include at least one of the volatile memory 121 and the nonvolatile memory 122.

The input module 130 may receive commands or data used to the elements (e.g., the processor 110, the sensor module 161 or the sound output module 163) of the electronic apparatus 101 from the outside of the electronic apparatus 101 (e.g., the user or the external electronic apparatus 102).

The input module 130 may include a first input module 131 for receiving commands or data from the user and a second input module 132 for receiving commands or data from the external electronic apparatus 102. The first input module 131 may include a microphone, a mouse, a keyboard, a key (e.g., a button) or a pen (e.g., a passive pen or an active pen). The second input module 132 may support a designated protocol capable of connecting to the external electronic apparatus 102 by wire or wirelessly. According to an embodiment, the second input module 132 may include a high definition multimedia interface (HDMI), a universal serial bus (USB) interface, an SD card interface or an audio interface. The second input module 132 may include a connector physically connected to the external electronic apparatus 102, for example, an HDMI connector, a USB connector, an SD card connector, or an audio connector (e.g., a headphone connector).

The display module 140 visually provides information to the user. The display module 140 may include the display panel 141, a scan driver 142 and the data driver 143. The display module 140 may further include a window, a chassis and a bracket to protect the display panel 141.

The display panel 141 may include a liquid crystal display panel, an organic light emitting display panel or an inorganic light emitting display panel. A type of the display panel 141 is not particularly limited. The display panel 141 may be a rigid type or a flexible type capable of being rolled or folded. The display module 140 may further include a supporter or a heat dissipation member supporting the display panel 141.

The scan driver 142 may be mounted on the display panel 141 as a driving chip. Alternatively, the scan driver 142 may be integrated on the display panel 141. In an embodiment, for example, the scan driver 142 may include an amorphous silicon TFT gate driver circuit (ASG) integrated on the display panel 141, a low temperature polycrystalline silicon (LTPS) TFT gate driver circuit integrated on the display panel 141, or an oxide semiconductor TFT gate driver circuit (OSG) integrated on the display panel 141. The scan driver 142 receives a control signal from the controller and outputs the scan signals to the display panel 141 in response to the control signal.

The display module 140 may further include a light emission driver. The light emission driver outputs a light emission control signal to the display panel 141 in response to a control signal received from the controller. The light emission driver may be formed independently from the scan driver 142. Alternatively, the light emission driver and the scan driver 142 may be integrally formed.

The data driver 143 receives a control signal from the controller and converts the image data into an analog voltage (e.g., the data voltage) and output the data voltages to the display panel 141 in response to the control signal.

The data driver 143 may be integrated into another element (e.g., the controller). The functions of the interface conversion circuit and the timing control circuit of the controller described above may be integrated into the data driver 143.

The display module 140 may further include a voltage generating circuit. The voltage generating circuit may output various voltages for driving the display panel 141.

The power module 150 supplies power to elements of the electronic apparatus 101. The power module 150 may include a battery which supplies a power voltage. The battery may include a non-rechargeable primary cell, a rechargeable secondary cell or a fuel cell. The power module 150 may include a power management integrated circuit (PMIC). The PMIC supplies optimized power to each of the above-described modules and modules described later. The power module 150 may include a wireless power transmission/reception member electrically connected to the battery. The wireless power transmission/reception member may include a plurality of antenna radiators in a form of coils.

The electronic apparatus 101 may further include the embedded module 160 and the external module 170. The embedded module 160 may include the sensor module 161, the antenna module 162 and the sound output module 163. The external module 170 may include the camera module 171, a light module 172 and the communication module 173.

The sensor module 161 may detect an input by a user's body or an input by the pen among the first input module 131, and generate an electrical signal or data value corresponding to the input. The sensor module 161 may include at least one of the fingerprint sensor 161-1, the input sensor 161-2 and a digitizer 161-3.

The fingerprint sensor 161-1 may generate a data value corresponding to a user's fingerprint. The fingerprint sensor 161-1 may include one of an optical fingerprint sensor or a capacitive fingerprint sensor.

The input sensor 161-2 may generate data values corresponding to coordinate information of the input by the user's body or the input by the pen. The input sensor 161-2 generates a capacitance change due to an input as a data value. The input sensor 161-2 may detect an input by the passive pen or transmit/receive data to/from the active pen.

The input sensor 161-2 may measure biosignals such as a blood pressure, a moisture, or a body fat. For example, when a user touches a part of his body to a sensor layer or a sensing panel and does not move for a certain period of time, the input sensor 161-2 may detect the biosignal based on a change in an electric field caused by the part of the body so that the display module 140 may output user's desired information.

The digitizer 161-3 may generate a data value corresponding to the coordinate information input by the pen. The digitizer 161-3 generates an amount of electromagnetic change by the input as a data value. The digitizer 161-3 may detect an input by the passive pen or transmit/receive data to/from the active pen.

At least one selected from the fingerprint sensor 161-1, the input sensor 161-2 and the digitizer 161-3 may be formed as a sensor layer on the display panel 141 through a continuous process. The fingerprint sensor 161-1, the input sensor 161-2 and the digitizer 161-3 may be disposed on the display panel 141. At least one selected from the fingerprint sensor 161-1, the input sensor 161-2 and the digitizer 161-3, for example, the digitizer 161-3, may be disposed under the display panel 141.

At least two selected from the fingerprint sensor 161-1, the input sensor 161-2 and the digitizer 161-3 may be integrated into the sensing panel through the same process. When at least two selected from the fingerprint sensor 161-1, the input sensor 161-2 and the digitizer 161-3 are integrated into the sensing panel, the sensing panel may be disposed between the display panel 141 and a window disposed over an upper surface of the display panel 141. According to an embodiment, the sensing panel may be disposed on the window. The invention may not be limited to a position of the sensing panel.

At least one selected from the fingerprint sensor 161-1, the input sensor 161-2 and the digitizer 161-3 may be embedded in the display panel 141. In an embodiment, for example, at least one selected from the fingerprint sensor 161-1, the input sensor 161-2 and the digitizer 161-3 is formed simultaneously with the display panel 141 through a process of forming elements included in the display panel 141 (e.g., light emitting elements, transistors, etc.).

In addition, the sensor module 161 may generate an electrical signal or a data value corresponding to an internal state or an external state of the electronic apparatus 101. In an embodiment, for example, the sensor module 161 may further include a gesture sensor, a gyro sensor, a barometric pressure sensor, a magnetic sensor, an acceleration sensor, a grip sensor, a proximity sensor, a color sensor, an IR (infrared) sensor, a biosensor, a temperature sensor, a humidity sensor or an illuminance sensor.

The antenna module 162 may include one or more antennas for transmitting a signal or power to outside or receiving a signal or power from outside. According to an embodiment, the communication module 173 may transmit a signal to an external electronic apparatus or receive a signal from an external electronic apparatus through an antenna suitable for a communication method. An antenna pattern of the antenna module 162 may be integrated with an element of the display module 140 (e.g., the display panel 141) or the input sensor 161-2.

The sound output module 163 is a device for outputting sound signals to the outside of the electronic apparatus 101. In an embodiment, for example, the sound output module 163 may include a speaker used for general purposes such as playing multimedia or recording and a receiver used exclusively for receiving a call. According to an embodiment, the receiver may be formed integrally with or separately from the speaker. A sound output pattern of the sound output module 163 may be integrated with the display module 140.

The camera module 171 may capture still images and moving images. According to an embodiment, the camera module 171 may include one or more lenses, an image sensor or an image signal processor. The camera module 171 may further include an infrared camera capable of determining a presence or an absence of a user, the user's location and the user's gaze.

The light module 172 may provide a light. The light module 172 may include a light emitting diode or a xenon lamp. The light module 172 may operate in conjunction with the camera module 171 or operate independently.

The communication module 173 may support establishment of a wired or wireless communication channel between the electronic apparatus 101 and the external electronic apparatus 102 and communication through the established communication channel. The communication module 173 may include one or both of a wireless communication module such as a cellular communication module, a short-distance wireless communication module, or a global navigation satellite system (GNSS) communication module and a wired communication module such as a local area network (LAN) communication module, or a power line communication module. The communication module 173 may communicate with the external electronic apparatus 102 through a short-range communication network such as Bluetooth, WiFi direct or infrared data association (IrDA) or a long-distance communication network such as a cellular network, the Internet, or a computer network (e.g., LAN or WAN). The various types of communication modules 173 described above may be implemented as a single chip or may be implemented as separate chips.

The input module 130, the sensor module 161 and the camera module 171 may be used to control the operation of the display module 140 in conjunction with the processor 110.

The processor 110 outputs commands or data to the display module 140, the sound output module 163, the camera module 171 or the light module 172 based on the input data received from the input module 130. In an embodiment, for example, the processor 110 may generate image data corresponding to input data applied through a mouse or an active pen, and output the generated image data to the display module 140 or the processor 110 may generate command data corresponding to the input data and output the generated command data to the camera module 171 or the light module 172. When input data is not received from the input module 130 for a certain period of time, the processor 110 converts an operation mode of the electronic apparatus 101 into a low power mode or a sleep mode so that a power consumption of the electronic apparatus 101 may be reduced.

The processor 110 outputs commands or data to the display module 140, the sound output module 163, the camera module 171 or the light module 172 based on sensed data received from the sensor module 161. In an embodiment, for example, the processor 110 may compare authentication data applied by the fingerprint sensor 161-1 with authentication data stored in the memory 120, and then execute an application according to the comparison result. The processor 110 may execute commands or output corresponding image data to the display module 140 based on the sensed data sensed by the input sensor 161-2 or the digitizer 161-3. When the sensor module 161 includes a temperature sensor, the processor 110 may receive temperature data for the temperature measured from the sensor module 161 and may further perform luminance correction on the image data based on the temperature data.

The processor 110 may receive determined data about the presence or the absence of the user, the user's location and the user's gaze from the camera module 171. The processor 110 may further perform luminance correction on the image data based on the determined data. In an embodiment, for example, the processor 110, which determines the presence or the absence of the user through an input from the camera module 171, may display image data having the luminance corrected by the data converting circuit 112-2 or the gamma correction circuit 112-3 to the display module 140.

Some of the above elements may be connected to each other through a communication method between peripheral devices such as a bus, a general purpose input/output (GPIO), a serial peripheral interface (SPI), a mobile industry processor interface (MIPI), or an ultra path interconnect (UPI) link to exchange signals (e.g., commands or data) with each other. The processor 110 may communicate with the display module 140 through an agreed interface. In an embodiment, for example, the processor 110 may communicate with the display module 140 through any one of the above communication methods. The invention may not be limited to the above communication methods.

The electronic apparatus 101 according to various embodiments disclosed in the disclosure may be various types of apparatuses. In an embodiment, for example, the electronic apparatus 101 may be a portable communication apparatus (e.g., a smart phone), a computer apparatus, a portable multimedia apparatus, a portable medical apparatus, a camera, a wearable device or a home appliance. The electronic apparatus 101 according to the embodiment of the disclosure may not be limited to the aforementioned apparatuses.

For example, the display panel 100 of FIG. 1 may correspond to the display panel 141 of FIG. 18. For example, the driving controller 200 of FIG. 1 may correspond to the controller of the auxiliary processor 112 of FIG. 18. For example, the gate driver 300 of FIG. 1 may correspond to the scan driver 142 of FIG. 18. For example, the data driver 500 of FIG. 1 may correspond to the data driver 143 of FIG. 18.

According to embodiments of the display apparatus, the method of driving the display apparatus and the electronic apparatus including the display apparatus, the difference of kickback of the input data which is generated due to the demux switching of the demux circuit may be compensated such that the display quality of the display panel may be enhanced.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display apparatus comprising:
a display panel;
a data driver which outputs a data voltage to the display panel;
a demux circuit which alternately outputs the data voltage to adjacent data lines of the display panel; and
a driving controller which compensates a difference of kickback of input data which is generated due to a demux switching of the demux circuit.

2. The display apparatus of claim 1, wherein the driving controller determines a position corresponding to the input data in the display panel,
wherein the driving controller compensates for the input data of a pixel having a relatively high degree of the kickback based on the position, and
wherein the driving controller does not compensate for the input data of a pixel having a relatively low degree of the kickback based on the position.

3. The display apparatus of claim 2, wherein the driving controller comprises:
a position determiner which receives first input data and second input data and determines a first position corresponding to the first input data in the display panel and a second position corresponding to the second input data in the display panel;
a kickback compensation lookup table which receives the first input data and outputs an offset value corresponding to the first input data when a degree of kickback of a pixel in the first position is relatively great, and
an adder which adds the first input data and the offset value to generate first output data when the degree of kickback of the pixel in the first position is relatively high, and
wherein the driving controller outputs the second input data as second output data when a degree of kickback of a pixel in the second position is relatively low.

4. The display apparatus of claim 1, wherein the data driver comprises an output amplifier which outputs the data voltage,
wherein the demux circuit comprises:
a first switch connected to the output amplifier and activated in response to a first switching signal; and
a second switch connected to the output amplifier and activated in response to a second switching signal, and
wherein the display panel comprises:
a first gate lines which applies a first gate signal;
a second gate line which applies a second gate signal;
a third gate line which applies a third gate signal;
a first data line connected to the first switch;
a second data line connected to the second switch;
an 1A pixel connected to the first gate line and the first data line;
an 1B pixel connected to the first gate line and the second data line;
a 2A pixel connected to the second gate line and the first data line;
a 2B pixel connected to the second gate line and the second data line;
a 3A pixel connected to the third gate line and the first data line; and
a 3B pixel connected to the third gate line and the second data line.

5. The display apparatus of claim 4,
wherein the first switching signal has an active level in a first period, the second switching signal has an inactive level in the first period, the first gate signal has an inactive level in the first period, the second gate signal has an inactive level in the first period, the third gate signal has an inactive level in the first period and the data voltage in the first period is an 1A data voltage corresponding to the 1A pixel,
wherein the first switching signal has an inactive level in a second period subsequent to the first period, the second switching signal has an active level in the second period, the first gate signal sequentially has the inactive level and an active level in the second period, the second gate signal has the inactive level in the second period, the third gate signal has the inactive level in the second period and the data voltage in the second period is an 1B data voltage corresponding to the 1B pixel,
wherein the first switching signal has the inactive level in a third period subsequent to the second period, the second switching signal has the inactive level in the third period, the first gate signal maintains the active level in the third period, the second gate signal has the inactive level in the third period and the third gate signal has the inactive level in the third period,
wherein the first switching signal has the active level in a fourth period subsequent to the third period, the second switching signal has the inactive level in the fourth period, the first gate signal has the inactive level in the fourth period, the second gate signal has the inactive level in the fourth period, the third gate signal has the inactive level in the fourth period and the data voltage in the fourth period is a 2A data voltage corresponding to the 2A pixel,
wherein the first switching signal has the inactive level in a fifth period subsequent to the fourth period, the second switching signal has the active level in the fifth period, the first gate signal has the inactive level in the fifth period, the second gate signal sequentially has the inactive level and an active level in the fifth period, the third gate signal has the inactive level in the fifth period and the data voltage in the fifth period is a 2B data voltage corresponding to the 2B pixel,
wherein the first switching signal has the inactive level in a sixth period subsequent to the fifth period, the second switching signal has the inactive level in the sixth period, the first gate signal has the inactive level in the sixth period, the second gate signal maintains the active level in the sixth period and the third gate signal has the inactive level in the sixth period,
wherein the first switching signal has the active level in a seventh period subsequent to the sixth period, the second switching signal has the inactive level in the seventh period, the first gate signal has the inactive level in the seventh period, the second gate signal has the inactive level in the seventh period, the third gate signal has the inactive level in the seventh period and the data voltage in the seventh period is a 3A data voltage corresponding to the 3A pixel,
wherein the first switching signal has the inactive level in an eighth period subsequent to the seventh period, the second switching signal has the active level in the eighth period, the first gate signal has the inactive level in the eighth period, the second gate signal has the inactive level in the eighth period, the third gate signal sequentially has the inactive level and an active level in the eighth period and the data voltage in the eighth period is a 3B data voltage corresponding to the 3B pixel, and
wherein the first switching signal has the inactive level in a ninth period subsequent to the eighth period, the second switching signal has the inactive level in the ninth period, the first gate signal has the inactive level in the ninth period, the second gate signal has the inactive level in the ninth period and the third gate signal maintains the active level in the ninth period.

6. The display apparatus of claim 5, wherein a degree of kickback of the 1A pixel is greater than a degree of kickback of the 1B pixel,
wherein a degree of kickback of the 2A pixel is greater than a degree of kickback of the 2B pixel, and
wherein a degree of kickback of the 3A pixel is greater than a degree of kickback of the 3B pixel.

7. The display apparatus of claim 4,
wherein the first switching signal has an active level in a first period, the second switching signal has an inactive level in the first period, the first gate signal has an inactive level in the first period, the second gate signal has an inactive level in the first period, the third gate signal has an inactive level in the first period and the data voltage in the first period is an 1A data voltage corresponding to the 1A pixel,
wherein the first switching signal has an inactive level in a second period subsequent to the first period, the second switching signal has an active level in the second period, the first gate signal sequentially has the inactive level and an active level in the second period, the second gate signal has the inactive level in the second period, the third gate signal has the inactive level in the second period and the data voltage in the second period is an 1B data voltage corresponding to the 1B pixel,
wherein the first switching signal has the inactive level in a third period subsequent to the second period, the second switching signal has the inactive level in the third period, the first gate signal maintains the active level in the third period, the second gate signal has the inactive level in the third period and the third gate signal has the inactive level in the third period,
wherein the first switching signal has the inactive level in a fourth period subsequent to the third period, the second switching signal has the active level in the fourth period, the first gate signal has the inactive level in the fourth period, the second gate signal has the inactive level in the fourth period, the third gate signal has the inactive level in the fourth period and the data voltage in the fourth period is a 2B data voltage corresponding to the 2B pixel,
wherein the first switching signal has the active level in a fifth period subsequent to the fourth period, the second switching signal has the inactive level in the fifth period, the first gate signal has the inactive level in the fifth period, the second gate signal sequentially has the inactive level and an active level in the fifth period, the third gate signal has the inactive level in the fifth period and the data voltage in the fifth period is a 2A data voltage corresponding to the 2A pixel,
wherein the first switching signal has the inactive level in a sixth period subsequent to the fifth period, the second switching signal has the inactive level in the sixth period, the first gate signal has the inactive level in the sixth period, the second gate signal maintains the active level in the sixth period and the third gate signal has the inactive level in the sixth period,
wherein the first switching signal has the active level in a seventh period subsequent to the sixth period, the second switching signal has the inactive level in the seventh period, the first gate signal has the inactive level in the seventh period, the second gate signal has the inactive level in the seventh period, the third gate signal has the inactive level in the seventh period and the data voltage in the seventh period is a 3A data voltage corresponding to the 3A pixel,
wherein the first switching signal has the inactive level in an eighth period subsequent to the seventh period, the second switching signal has the active level in the eighth period, the first gate signal has the inactive level in the eighth period, the second gate signal has the inactive level in the eighth period, the third gate signal sequentially has the inactive level and an active level in the eighth period and the data voltage in the eighth period is a 3B data voltage corresponding to the 3B pixel, and
wherein the first switching signal has the inactive level in a ninth period subsequent to the eighth period, the second switching signal has the inactive level in the ninth period, the first gate signal has the inactive level in the ninth period, the second gate signal has the inactive level in the ninth period and the third gate signal maintains the active level in the ninth period.

8. The display apparatus of claim 7, wherein a degree of kickback of the 1A pixel is greater than a degree of kickback of the 1B pixel,
wherein a degree of kickback of the 2B pixel is greater than a degree of kickback of the 2A pixel, and
wherein a degree of kickback of the 3A pixel is greater than a degree of kickback of the 3B pixel.

9. The display apparatus of claim 4,
wherein the first switching signal has an active level in a first period, the second switching signal has an inactive level in the first period, the first gate signal has an inactive level in the first period, the second gate signal has an inactive level in the first period, the third gate signal has an inactive level in the first period and the data voltage in the first period is an 1A data voltage corresponding to the 1A pixel,
wherein the first switching signal has an inactive level in a second period subsequent to the first period, the second switching signal has an active level in the second period, the first gate signal sequentially has the inactive level and an active level in the second period, the second gate signal has the inactive level in the second period, the third gate signal has the inactive level in the second period and the data voltage in the second period is an 1B data voltage corresponding to the 1B pixel,
wherein the first switching signal has the inactive level in a third period subsequent to the second period, the second switching signal has the active level in the third period, the first gate signal maintains the active level in the third period, the second gate signal has the inactive level in the third period and the third gate signal has the inactive level in the third period,
wherein the first switching signal has the inactive level in a fourth period subsequent to the third period, the second switching signal has the active level in the fourth period, the first gate signal has the inactive level in the fourth period, the second gate signal has the inactive level in the fourth period, the third gate signal has the inactive level in the fourth period and the data voltage in the fourth period is a 2B data voltage corresponding to the 2B pixel,
wherein the first switching signal has the active level in a fifth period subsequent to the fourth period, the second switching signal has the inactive level in the fifth period, the first gate signal has the inactive level in the fifth period, the second gate signal sequentially has the inactive level and an active level in the fifth period, the third gate signal has the inactive level in the fifth period and the data voltage in the fifth period is a 2A data voltage corresponding to the 2A pixel,
wherein the first switching signal has the active level in a sixth period subsequent to the fifth period, the second switching signal has the inactive level in the sixth period, the first gate signal has the inactive level in the sixth period, the second gate signal maintains the active level in the sixth period and the third gate signal has the inactive level in the sixth period,
wherein the first switching signal has the active level in a seventh period subsequent to the sixth period, the second switching signal has the inactive level in the seventh period, the first gate signal has the inactive level in the seventh period, the second gate signal has the inactive level in the seventh period, the third gate signal has the inactive level in the seventh period and the data voltage in the seventh period is a 3A data voltage corresponding to the 3A pixel,
wherein the first switching signal has the inactive level in an eighth period subsequent to the seventh period, the second switching signal has the active level in the eighth period, the first gate signal has the inactive level in the eighth period, the second gate signal has the inactive level in the eighth period, the third gate signal sequentially has the inactive level and an active level in the eighth period and the data voltage in the eighth period is a 3B data voltage corresponding to the 3B pixel, and
wherein the first switching signal has the inactive level in a ninth period subsequent to the eighth period, the second switching signal has the inactive level in the ninth period, the first gate signal has the inactive level in the ninth period, the second gate signal has the inactive level in the ninth period and the third gate signal maintains the active level in the ninth period.

10. The display apparatus of claim 9, wherein a degree of kickback of the 1A pixel is greater than a degree of kickback of the 1B pixel,
wherein a degree of kickback of the 2B pixel is greater than a degree of kickback of the 2A pixel, and
wherein a degree of kickback of the 3A pixel is greater than a degree of kickback of the 3B pixel.

11. The display apparatus of claim 1, wherein the data driver comprises an output amplifier which outputs the data voltage,
wherein the demux circuit comprises:
a first switch connected to the output amplifier and activated in response to a first switching signal;
a second switch connected to the output amplifier and activated in response to a second switching signal; and
a third switch connected to the output amplifier and activated in response to a third switching signal, and
wherein the display panel comprises:
a first gate lines which applies a first gate signal;
a second gate line which applies a second gate signal;
a third gate line which applies a third gate signal;
a first data line connected to the first switch;
a second data line connected to the second switch;
a third data line connected to the third switch;
an 1A pixel connected to the first gate line and the first data line;
an 1B pixel connected to the first gate line and the second data line;
an 1C pixel connected to the first gate line and the third data line;
a 2A pixel connected to the second gate line and the first data line;
a 2B pixel connected to the second gate line and the second data line;
a 2C pixel connected to the second gate line and the third data line;
a 3A pixel connected to the third gate line and the first data line;
a 3B pixel connected to the third gate line and the second data line; and
a 3C pixel connected to the third gate line and the third data line.

12. The display apparatus of claim 11,
wherein the first switching signal has an active level in a first period, the second switching signal has an inactive level in the first period, the third switching signal has an inactive level in the first period, the first gate signal has an inactive level in the first period, the second gate signal has an inactive level in the first period, the third gate signal has an inactive level in the first period and the data voltage in the first period is an 1A data voltage corresponding to the 1A pixel,
wherein the first switching signal has an inactive level in a second period subsequent to the first period, the second switching signal has an active level in the second period, the third switching signal has the inactive level in the second period, the first gate signal has the inactive level in the second period, the second gate signal has the inactive level in the second period, the third gate signal has the inactive level in the second period and the data voltage in the second period is an 1B data voltage corresponding to the 1B pixel,
wherein the first switching signal has the inactive level in a third period subsequent to the second period, the second switching signal has the inactive level in the third period, the third switching signal has an active level in the third period, the first gate signal sequentially has the inactive level and an active level in the third period, the second gate signal has the inactive level in the third period, the third gate signal has the inactive level in the third period and the data voltage in the third period is an 1C data voltage corresponding to the 1C pixel,
wherein the first switching signal has the inactive level in a fourth period subsequent to the third period, the second switching signal has the inactive level in the fourth period, the third switching signal has the inactive level in the fourth period, the first gate signal maintains the active level in the fourth period, the second gate signal has the inactive level in the fourth period and the third gate signal has the inactive level in the fourth period,
wherein the first switching signal has the active level in a fifth period subsequent to the fourth period, the second switching signal has the inactive level in the fifth period, the third switching signal has the inactive level in the fifth period, the first gate signal has the inactive level in the fifth period, the second gate signal has the inactive level in the fifth period, the third gate signal has the inactive level in the fifth period and the data voltage in the fifth period is a 2A data voltage corresponding to the 2A pixel,
wherein the first switching signal has the inactive level in a sixth period subsequent to the fifth period, the second switching signal has the active level in the sixth period, the third switching signal has the inactive level in the sixth period, the first gate signal has the inactive level in the sixth period, the second gate signal has the inactive level in the sixth period, the third gate signal has the inactive level in the sixth period and the data voltage in the sixth period is a 2B data voltage corresponding to the 2B pixel,
wherein the first switching signal has the inactive level in a seventh period subsequent to the sixth period, the second switching signal has the inactive level in the seventh period, the third switching signal has the active level in the seventh period, the first gate signal has the inactive level in the seventh period, the second gate signal sequentially has the inactive level and an active level in the seventh period, the third gate signal has the inactive level in the seventh period and the data voltage in the seventh period is a 2C data voltage corresponding to the 2C pixel,
wherein the first switching signal has the inactive level in an eighth period subsequent to the seventh period, the second switching signal has the inactive level in the eighth period, the third switching signal has the inactive level in the eighth period, the first gate signal has the inactive level in the eighth period, the second gate signal maintains the active level in the eighth period and the third gate signal has the inactive level in the eighth period,
wherein the first switching signal has the active level in a ninth period subsequent to the eighth period, the second switching signal has the inactive level in the ninth period, the third switching signal has the inactive level in the ninth period, the first gate signal has the inactive level in the ninth period, the second gate signal has the inactive level in the ninth period, the third gate signal has the inactive level in the ninth period and the data voltage in the ninth period is a 3A data voltage corresponding to the 3A pixel,
wherein the first switching signal has the inactive level in a tenth period subsequent to the ninth period, the second switching signal has the active level in the tenth period, the third switching signal has the inactive level in the tenth period, the first gate signal has the inactive level in the tenth period, the second gate signal has the inactive level in the tenth period, the third gate signal has the inactive level in the tenth period and the data voltage the tenth period is a 3B data voltage corresponding to the 3B pixel,
wherein the first switching signal has the inactive level in an eleventh period subsequent to the tenth period, the second switching signal has the inactive level in the eleventh period, the third switching signal has the active level in the eleventh period, the first gate signal has the inactive level in the eleventh period, the second gate signal has the inactive level in the eleventh period, the third gate signal sequentially has the inactive level and an active level in the eleventh period and the data voltage in the eleventh period is a 3C data voltage corresponding to the 3C pixel, and
wherein the first switching signal has the inactive level in a twelfth period subsequent to the eleventh period, the second switching signal has the inactive level in the twelfth period, the third switching signal has the inactive level in the twelfth period, the first gate signal has the inactive level in the twelfth period, the second gate signal has the inactive level in the twelfth period and the third gate signal maintains the active level in the twelfth period.

13. The display apparatus of claim 12, wherein a degree of kickback of the 1A pixel and a degree of kickback of the 1B pixel are greater than a degree of kickback of the 1C pixel,
wherein a degree of kickback of the 2A pixel and a degree of kickback of the 2B pixel are greater than a degree of kickback of the 2C pixel, and
wherein a degree of kickback of the 3A pixel and a degree of kickback of the 3B pixel are greater than a degree of kickback of the 3C pixel.

14. A method of driving a display apparatus, the method comprising:
compensating a difference of kickback of input data generated due to a demux switching of a demux circuit;
generating a data voltage based on output data in which the difference of the kickback is compensated; and
outputting the data voltage to adjacent data lines of a display panel using the demux circuit.

15. The method of claim 14, wherein the compensating the difference of the kickback of the input data comprises determining a position corresponding to the input data in the display panel,
wherein input data of a pixel having a relatively high degree of kickback are compensated based on the position, and
wherein input data of a pixel having a relatively low degree of kickback are not compensated based on the position.

16. The method of claim 15, wherein the compensating the difference of the kickback of the input data further comprises:
determining an offset value corresponding to the input data when it is determined that a compensation of the input data is to be performed; and
adding the input data and the offset value when it is determined that the compensation of the input data is to be performed.

17. The method of claim 14, wherein a data driver comprises an output amplifier which outputs the data voltage,
wherein the demux circuit comprises:
a first switch connected to the output amplifier and activated in response to a first switching signal; and
a second switch connected to the output amplifier and activated in response to a second switching signal, and
wherein the display panel comprises:
a first gate lines which applies a first gate signal;
a second gate line which applies a second gate signal;
a third gate line which applies a third gate signal;
a first data line connected to the first switch;
a second data line connected to the second switch;
an 1A pixel connected to the first gate line and the first data line;
an 1B pixel connected to the first gate line and the second data line;
a 2A pixel connected to the second gate line and the first data line;
a 2B pixel connected to the second gate line and the second data line;
a 3A pixel connected to the third gate line and the first data line; and
a 3B pixel connected to the third gate line and the second data line.

18. The method of claim 14, wherein a data driver comprises an output amplifier which output the data voltage,
wherein the demux circuit comprises:
a first switch connected to the output amplifier and activated in response to a first switching signal;
a second switch connected to the output amplifier and activated in response to a second switching signal; and
a third switch connected to the output amplifier and activated in response to a third switching signal, and
wherein the display panel comprises:
a first gate lines which applies a first gate signal;
a second gate line which applies a second gate signal;
a third gate line which applies a third gate signal;
a first data line connected to the first switch;
a second data line connected to the second switch;
a third data line connected to the third switch;
an 1A pixel connected to the first gate line and the first data line;
an 1B pixel connected to the first gate line and the second data line;
an 1C pixel connected to the first gate line and the third data line;
a 2A pixel connected to the second gate line and the first data line;
a 2B pixel connected to the second gate line and the second data line;
a 2C pixel connected to the second gate line and the third data line;
a 3A pixel connected to the third gate line and the first data line;
a 3B pixel connected to the third gate line and the second data line; and
a 3C pixel connected to the third gate line and the third data line.

19. An electronic apparatus comprising:
a display panel;
a data driver which outputs a data voltage to the display panel;
a demux circuit which alternately outputs the data voltage to adjacent data lines of the display panel;
a driving controller which compensates a difference of kickback of input data which is generated due to a demux switching of the demux circuit; and
a processor which outputs input image data and an input control signal to the driving controller.
